(19) United States
(12) Patent Application Publication
(10) Pub. No.: US 2025/0164795 A1
(43) Pub. Date: May 22, 2025

(54) OPTICAL LAYERS TO IMPROVE PERFORMANCE OF EYEPIECES FOR USE WITH VIRTUAL AND AUGMENTED REALITY DISPLAY SYSTEMS

(71) Applicant: Magic Leap, Inc., Plantation, FL (US)

(72) Inventors: Robert D. TEKOLSTE, Fort Lauderdale, FL (US); Vikramjit SINGH, Pflugerville, TX (US); Chinmay KHANDEKAR, Sunnyvale, CA (US)

(73) Assignee: Magic Leap, Inc., Plantation, FL (US)

(21) Appl. No.: 18/875,645

(22) PCT Filed: Jun. 17, 2022
(86) PCT No.: PCT/US2022/073026

§ 371 Date: Dec. 16, 2024

(51) Int. Cl. G02B 27/01; G02B 5/18

(52) U.S. Cl. CPC G02B 27/0172; G02B 5/18

(57) ABSTRACT

Improved diffractive optical elements for use in an eyepiece for an extended reality system, The diffractive optical elements comprise a diffraction structure having a waveguide substrate, a surface grating positioned on a first side of the waveguide substrate, and one or more optical layer pairs disposed between the waveguide substrate and the surface grating. Each optical layer pair comprises a low index layer and a high index layer disposed directly on an exterior side of the low index layer.

### FIELD OF THE INVENTION

The present disclosure relates to virtual reality and augmented reality imaging and visualization systems, and more particularly, to improved eyepiece designs for the display systems for virtual reality and/or augmented reality systems.

### BACKGROUND

Modern computing and display technologies have facilitated the development of systems for so called “virtual reality” (VR) or “augmented reality” (AR) and/or “mixed-reality” (MR) experiences, wherein digitally reproduced images or portions thereof are presented to a user in a manner wherein they seem to be, or may be perceived as, real. A virtual reality, or “VR,” scenario typically involves presentation of digital or virtual image information without transparency to actual real-world visual input. An augmented reality, or “AR,” scenario typically involves presentation of digital or virtual image information as an augmentation to visualization of the actual world around the user. A mixed reality scenario is a version of an AR scenario, except with more extensive merging of the real world and virtual world in which physical objects in the real world and virtual objects may co-exist and interact in real-time. As used herein, the terms “extended reality” and “XR” are used to refer collectively to any of VR, AR and/or MR. In addition, the term “AR” means either, or both, AR and MR.

For example, referring to FIG. 1, an augmented reality scene (4) is depicted wherein a user of an AR technology sees a real-world park-like setting (6) featuring people, trees, buildings in the background, and a concrete platform (1120). In addition to these items, the user of the AR technology also perceives that he “sees” a robot statue (1110) standing upon the real-world platform (1120), and a cartoon-like avatar character (2) flying by which seems to be a personification of a bumble bee, even though these elements (2, 1110) do not exist in the real world. As it turns out, the human visual perception system is very complex, and producing a VR or AR technology that facilitates a comfortable, natural-feeling, rich presentation of virtual image elements amongst other virtual or real-world imagery elements is challenging.

There are numerous challenges when it comes to presenting 3D virtual content to a user of an XR system. A central premise of presenting 3D content to a user involves creating a perception of multiple depths. In other words, it may be desirable that some virtual content appear closer to the user, while other virtual content appears to be coming from farther away. Thus, to achieve 3D perception, the XR system should be configured to deliver virtual content at different focal planes relative to the user.

In order for a 3D display to produce a true sensation of depth, and more specifically, a simulated sensation of surface depth, it is desirable for each point in the display's visual field to generate the accommodative response corresponding to its virtual depth. If the accommodative response to a display point does not correspond to the virtual depth of that point, as determined by the binocular depth cues of convergence and stereopsis, the human visual system may experience an accommodation conflict, resulting in unstable imaging, harmful eye strain, headaches, and, in the absence of accommodation information, almost a complete lack of surface depth.

Therefore, there is a need for improved technologies to implement 3D displays that resolve these and other problems of the conventional approaches. The systems and techniques described herein are configured to work with the visual configuration of the typical human to address these challenges.

### SUMMARY

Embodiments of the present invention are directed to devices, systems and methods for facilitating XR interaction for one or more users. More specifically, disclosed herein are improved eyepiece designs for virtual reality and/or augmented reality display systems having improved performance over previous eyepiece designs. The presently disclosed eyepiece designs include innovative coating layers of an optical element of the display system which improve the functional performance of the eyepiece, such as tuning the diffraction efficiency selectively for certain colors, increasing the magnitude and uniformity of the diffraction efficiency of the eyepiece, increasing the combined exit pupil expander (CPE) efficiency of the eyepiece, and/or increasing the input coupling grating (ICG) launch efficiency of the eyepiece.

Accordingly, one embodiment disclosed herein is an eyepiece for an XR display system for delivering XR content to a user. The eyepiece comprises a diffractive optical element (DOE) to receive light associated with one or more frames of image data and direct the light to the user's eyes. The DOE comprises a diffraction structure having a waveguide substrate, a surface grating positioned on a first side of the waveguide substrate, and one or more optical layer pairs disposed between the waveguide substrate and the surface grating. The optical layer pair(s) may be disposed directly on first side of the waveguide substrate, or there may be one or more intermediate layers (also referred to herein as an “underlayer”) disposed between the optical layer pair(s) and the waveguide substrate. Each optical layer pair comprises a low index layer and a high index layer disposed directly on an exterior side of the low index layer. The terms “interior” and “exterior” are relative to a plane through a middle of a thickness of waveguide substrate, wherein the plane is the interior most position. The high index layer has a higher refractive index than the low index layer. The use of the innovative optical layer pair(s) are tuned to improve the uniformity of display of certain colors by the eyepiece by better matching the diffraction efficiency of the DOE to the bounce spacing (outcoupled beam density) and also the ICG launch efficiency, which are both dependent on angle of incidence of the light entering the eyepiece.

In another aspect, the DOE for the eyepiece may include a first optical layer pair on the first side of the waveguide substrate, and a second optical layer pair on a second side of the waveguide substrate (i.e., the side opposing the first side). The DOE may also include a second surface grating on the second side of the waveguide substrate, such that the second optical layer pair is between the waveguide substrate and the second surface grating. In still another aspect, the eyepiece may further include an input coupling grating disposed on the waveguide substrate.

In still another aspect, the DOE may include a first optical layer pair on a first side of the waveguide substrate, and a second optical layer pair disposed directly on the exterior of the first optical layer pair. In this way, the second optical layer pair can amplify the performance improvement of the first optical pair. One or more additional optical layer pair(s) can be stacked onto the other optical layer pair(s) to matching the diffraction efficiency of the DOE to the bounce spacing, or to adjust any other desired optical parameter of the eyepiece.

In another aspect, the waveguide substrate has a refractive index higher than the refractive index of the low index layer. In still another aspect, the waveguide substrate is formed of TAFD55 glass having a higher refraction index (about 2.0) than the refractive index of the low index layer. In still another aspect, the surface grating has a high refractive index greater than about 1.7. As used herein, the term “about” means plus or minus 10%.

In additional aspects of the eyepiece, the high index layer may be formed of Si₃N₄, ZrO₂, TiO₂, SiC, ZnTe, GP, BP and/or similar materials which have a high index of refraction (greater than 1.7), and low absorption (k<0.001). In another aspect, the high index layer may be applied to the DOE by any suitable process, such as spray deposition, application of a film, etc. The high index layer can also comprise organic filler based materials, such as organic UV and/or thermal curable resin composite composed of Sulphur, aromatic groups and high index nanoparticles (e.g., ZrO₂, TiO₂). The low index layer may be formed of inorganic material, such as MgF, SiO₂, and the like as well as organic materials such as normal UV and thermal curable resins which have a refractive index of about 1.53, as well as Teflon type materials having a refractive index of about 1.3. The low index coating layer may be applied to the DOE by any suitable process, such as spray deposition, application of a film, etc.

In other aspects, the surface grating has a low refractive index (i.e., lower than the refractive index of the high index layer) and may be applied to the DOE with a pattern of organic material over the high index layer of the optical coating layer using photolithography or imprint lithography with ultra-thin RLT (˜20 nm). A top surface layer also having a high refractive index higher than the low index layer may be disposed on top of the top surface grating. The top surface layer can form an interstitial layer between multiple stacked diffraction structures that removes any air space gap and provides a support structure for the stacked diffraction components.

Another embodiment disclosed herein is directed to an XR display system for delivering extended reality content to a user. The XR display system comprises an image-generating source to provide one or more frames of image data, a light modulator to transmit light associated with the one or more frames of image data, and an eyepiece having a DOE to receive the light associated with the one or more frames of image data and direct the light to the user's eyes. The DOE may be any of the DOEs described herein, including the DOE described above for one embodiment disclosed herein. Again, the DOE having the innovative optical layer pair(s) can be tuned to improve the uniformity of display of certain colors by the eyepiece by better matching the diffraction efficiency of the DOE to the bounce spacing (outcoupled beam density) and also the ICG launch efficiency, which are both dependent on angle of incidence of the light entering the eyepiece.

In additional aspects, the XR display system may include any combination of one or more of the additional aspects and features of the eyepiece embodiment, as described herein.

Another embodiment disclosed herein is directed to an XR system for generating and display XR content to a user. The XR system comprises a computer having a computer processor, memory, a storage device, and a software application(s) stored on the storage device and executable to program the computer to perform operations enabling the augmented reality system. The XR system includes an XR display system. The XR display system may be any suitable display system, such as XR headset having a display for displaying 3D virtual images (i.e., XR images). For example, the XR headset may include a frame structure configured to be worn on the head of a user. The frame structure carries an image-generating source to provide one or more frames of image data, a light modulator to transmit light associated with the one or more frames of image data, and an eyepiece having a DOE to receive the light associated with the one or more frames of image data and direct the light to the user's eyes. The DOE may be any of the DOEs described herein, including the DOE described above for one embodiment disclosed herein. Again, the DOE having the innovative optical layer pair(s) can be tuned to improve the uniformity of display of certain colors by the eyepiece by better matching the diffraction efficiency of the DOE to the bounce spacing (outcoupled beam density) and also the ICG launch efficiency, which are both dependent on angle of incidence of the light entering the eyepiece.

In additional aspects, the XR headset may include one or more outward facing image sensors (e.g., cameras, or other computer vision devices) for capturing images of the surrounding environment of the user. The XR headset may also include one or more other sensors, such as inward facing cameras (e.g., for eye-tracking, etc.), and one or more kinematic sensors (e.g., an inertial measurement unit (IMU), an accelerometer, a direction sensor, a compass, a gyroscope, a GPS sensor, a camera, and/or a computer vision, etc.).

In additional aspects, the XR display system may include any combination of one or more of the additional aspects and features of the eyepiece embodiment, as described herein.

Additional and other objects, features, and advantages of the invention are described in the detail description, figures and claims.

### BRIEF DESCRIPTION OF THE DRAWINGS

The drawings illustrate the design and utility of various embodiments of the present disclosure. Note that the figures are not drawn to scale, and that elements of similar structures or functions are represented by like reference numerals throughout the figures. To better appreciate how to obtain the above-recited and other advantages and objects of various embodiments of the disclosure, a more detailed description of the present disclosures briefly described above will be rendered by reference to specific embodiments thereof, which are illustrated in the accompanying drawings. Understanding that these drawings depict only typical embodiments of the disclosure and are not therefore to be considered limiting of its scope, the disclosure will be described and explained with additional specificity and detail through the use of the accompanying drawings in which:

FIG. 1 illustrates a user's view of augmented reality (AR) through a wearable AR user device, in one illustrated embodiment.

FIG. 2 illustrates a conventional stereoscopic 3-D simulation display system for an XR system.

FIG. 3 illustrates an improved approach to implement a stereoscopic 3-D simulation display system for an XR system according to some embodiments disclosed herein.

FIGS. 4A-4D illustrates various systems, subsystems, and components for addressing the objectives of providing a high-quality, comfortably-perceived display system for human XR.

FIG. 5 illustrates a plan view of an example configuration of an XR system utilizing the improved diffraction structure, according to some embodiments disclosed herein.

FIG. 6 illustrates a stacked waveguide assembly for use in an XR display system.

FIG. 7 illustrates a DOE for use in a display system, according to some embodiments disclosed herein.

FIGS. 8 and 9 illustrate example diffraction patterns for a DOE resulting in different exit beams directed toward the eye, according to some embodiments.

FIGS. 10 and 11 illustrate two waveguides into which a beam is injected.

FIG. 12 illustrates a stack of waveguides.

FIGS. 13A-13H illustrate several exemplary embodiments of diffraction structures for an improved eyepiece of an XR display system.

FIGS. 14A and 14B depict respective graphs of diffraction efficiency vs angle of incidence to compare a diffraction structure without an optical layer pair to a diffraction structure with an optical layer pair.

FIG. 14C is a schematic illustration of the diffraction structure with the single optical layer pair used to produce the results of FIG. 14B.

FIGS. 15A and 15B show a comparison of the color response of a single diffraction structure in three primary colors (red, blue, green, RGB) with (FIG. 15B) and without (FIG. 15A) the use of the optical layer pair.

FIG. 16A is a schematic illustration of a substrate structure having an ICG and a CPE.

FIG. 16B is a momentum space diagram of the substrate structure FIG. 16A in which each angle of incidence is mapped to the momentum of light, as indicated by the right box.

FIG. 16C shows a typical example of launch efficiency as a function of angle of incidence for the substrate structure of FIG. 16A

FIG. 16D illustrates the diffraction efficiency for s-polarized light undergoing the illustrated CPE diffraction in the substrate structure of FIG. 16A.

FIG. 16E depicts the number of hits with the surface grating for a propagation distance of 2 mm for light rays inside the waveguide of momentum outlines by the left box in FIG. 16B.

FIG. 16F schematically illustrates the simulated light distribution at the center of the CPE of the substrate structure of FIG. 16A.

FIGS. 17A and 17B illustrate a comparison of the uniformity of diffraction efficiency for a diffraction structure without the optical layer pair (FIG. 17A) compared to a diffraction structure 1300 with a single optical layer pair (FIG. 17B).

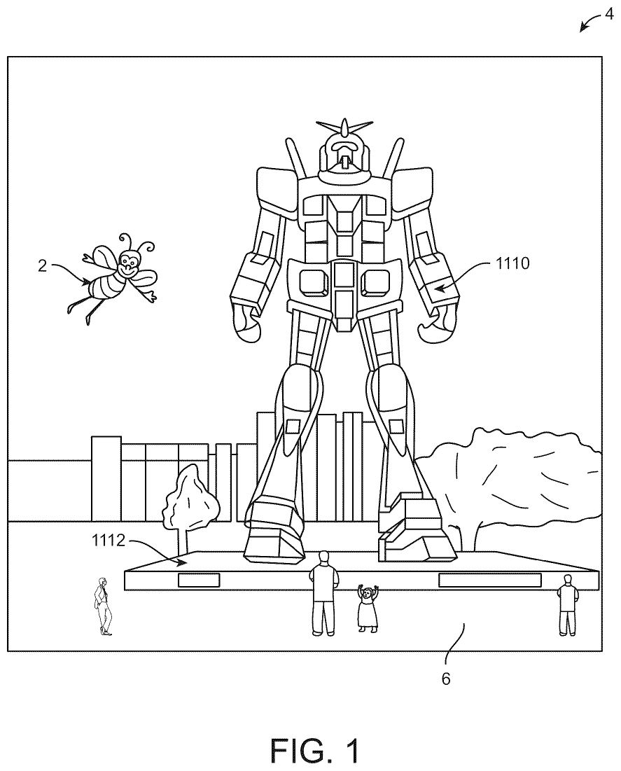

### DETAILED DESCRIPTION

The following describes various embodiments of improved eyepiece designs for extended reality (XR) display systems and XR systems for delivering extended reality content to a user. The improved eyepieces utilize additional optical layers on a diffractive optical element (DOE) of the eyepiece of an XR display system for receiving light associated with the frames of image data displayed on the XR display system. The disclosed eyepieces improve the functional performance of the eyepiece, such as tuning the diffraction efficiency selectively for certain colors, increasing the magnitude and uniformity of the diffraction efficiency of the eyepiece, increasing the combined exit pupil expander (CPE) efficiency of the eyepiece, and/or increasing the input coupling grating (ICG) launch efficiency, of the eyepiece.

According to some embodiments of the invention, a DOE is employed that has a diffraction structure that includes one or more optical layer pair(s) disposed between a waveguide substrate and a top grating surface. Typically, the waveguide substrate has a high refractive index and the top grating surface also has a high refractive index. One or more optical layer pair(s) are disposed between the waveguide substrate and the surface grating. Each optical layer pair comprises a low index layer and a high index layer disposed directly on an exterior side of the low index layer. As described herein, the optical layer pair(s) having a high index layer and a low index layer may be tuned to improve the performance of the DOE including improving the diffraction efficiency and the uniformity of display of discrete colors, increasing the magnitude and uniformity of the diffraction efficiency of the eyepiece, increasing the CPE efficiency of the eyepiece, and/or increasing the ICG launch efficiency of the eyepiece. Improving the diffraction efficiency has the benefit of allowing for “brighter” light outputs to the XR display.

### Display Systems According to Some Embodiments

This portion of the disclosure describes example display systems that may be used in conjunction with the improved diffraction structures disclosed herein.

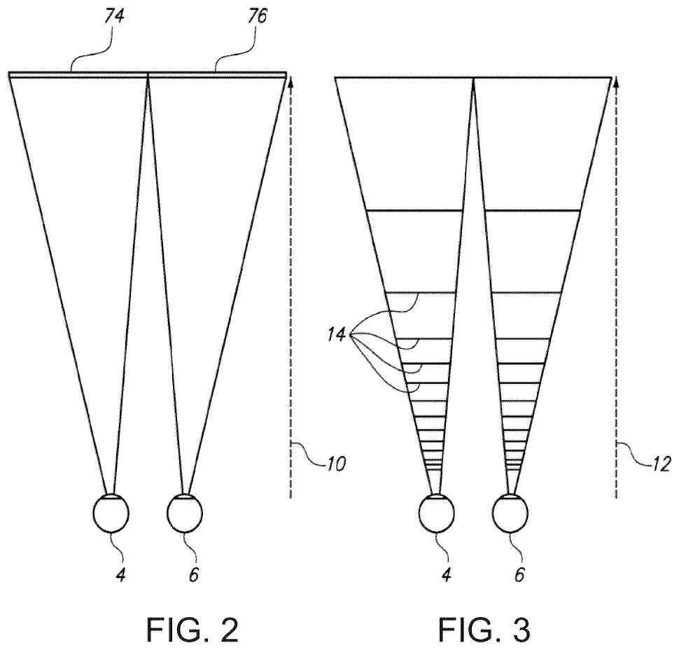

FIG. 2 illustrates a conventional stereoscopic 3-D simulation display system for an XR system. The display system typically has a separate display 74 and 76 for each eye 4 and 6, respectively, at a fixed radial focal distance 10 from the eye. This conventional approach fails to take into account many of the valuable cues utilized by the human eye and brain to detect and interpret depth in three dimensions, including the accommodation cue.

In fact, the typical human eye is able to interpret numerous layers of depth based upon radial distance, e.g., the human eye is able to interpret approximately 12 layers of depth. A near field limit of about 0.25 meters is about the closest depth of focus; a far-field limit of about 3 meters means that any item farther than about 3 meters from the human eye receives infinite focus. The layers of focus get more and more thin as one gets closer to the eye; in other words, the eye is able to perceive differences in focal distance that are quite small relatively close to the eye, and this effect dissipates as objects fall farther away from the eye. At an infinite object location, a depth of focus/dioptric spacing value is about ⅓ diopters.

FIG. 3 illustrates an improved approach to implement a stereoscopic 3-D simulation display system for use in an AR system according to some embodiments of the invention, where two complex images are displayed, one for each eye 4 and 6, with various radial focal depths (12) for various aspects (14) of each image utilized to provide each eye with the perception of three dimensional depth layering within the perceived image. Since there are multiple focal planes (e.g., 12 focal planes) between the eye of the user and infinity, these focal planes, and the data within the depicted relationships, may be utilized to position virtual elements within an augmented reality scenario for a user's viewing, because the human eye is constantly sweeping around to utilize the focal planes to perceive depth. While this figure shows a specific number of focal planes at various depths, it is noted that an implementation of the invention may use any number of focal planes as necessary for the specific application desired, and the invention is therefore not limited to devices having only to the specific number of focal planes shown in any of the figures in the present disclosure.

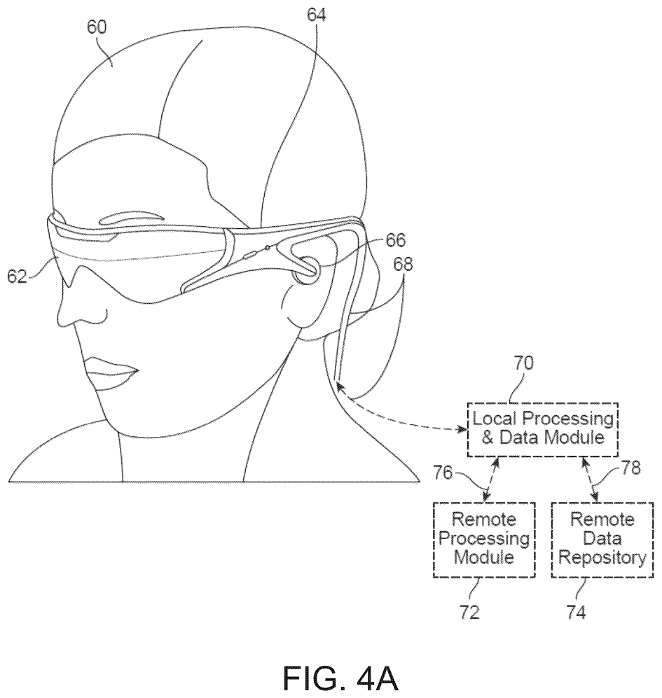

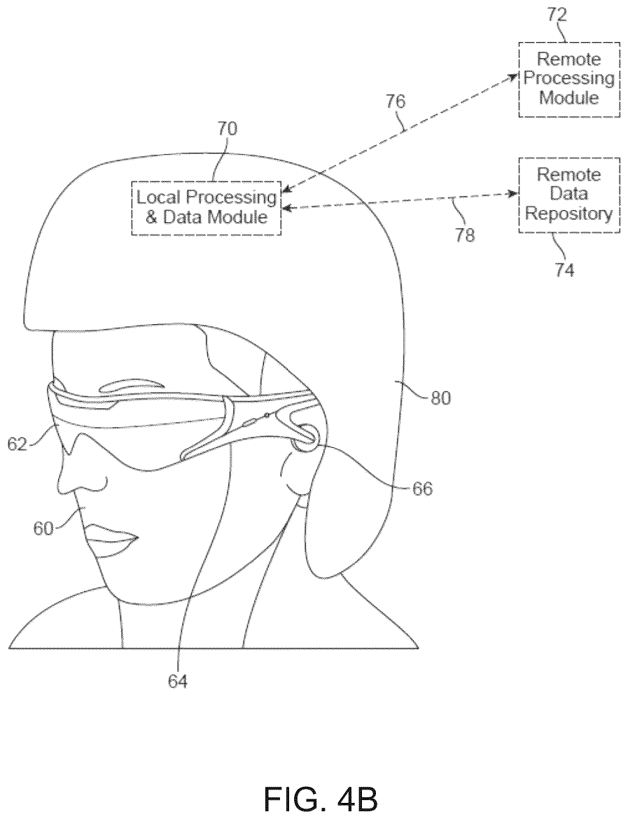

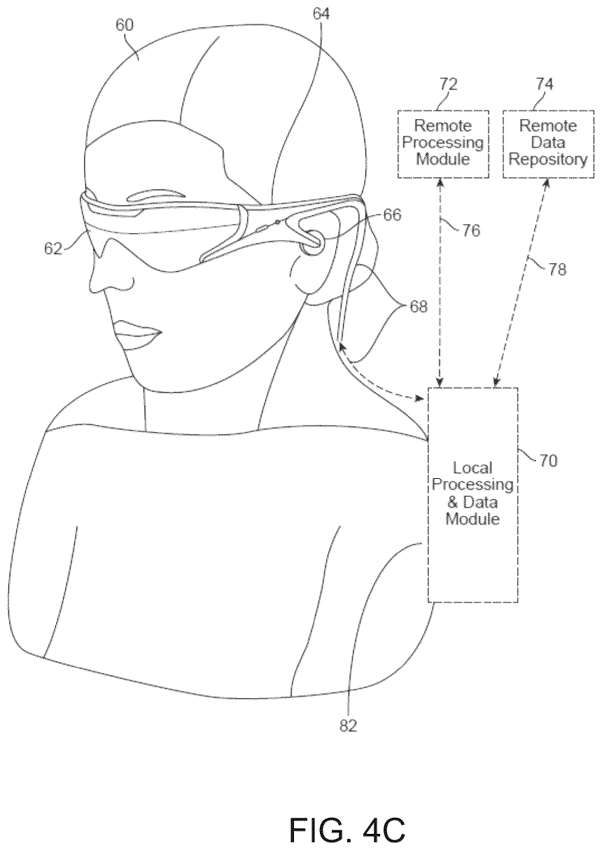

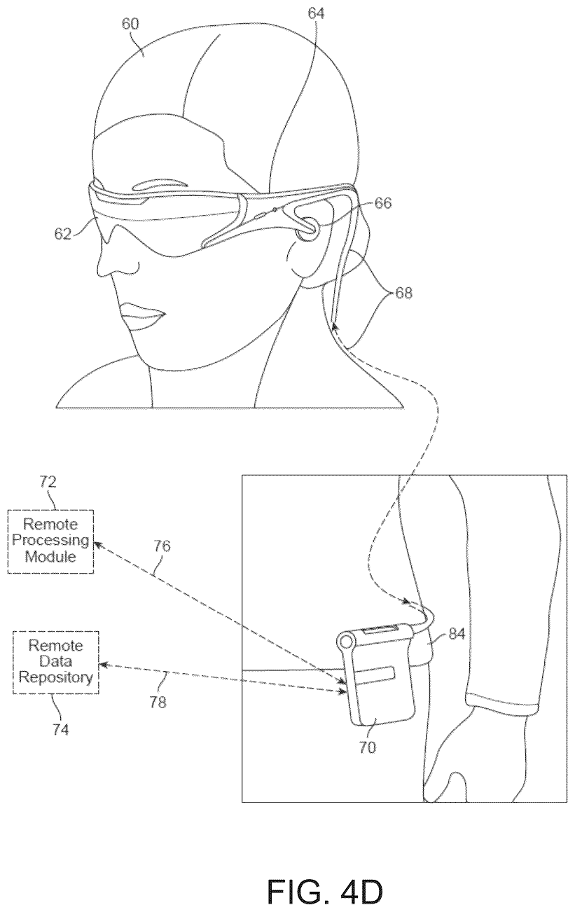

Referring to FIGS. 4A-4D, some general componentry options for an XR system are illustrated according to some embodiments of the invention. In the portions of the detailed description which follow the discussion of FIGS. 4A-4D, various systems, subsystems, and components are presented for addressing the objectives of providing a high-quality, comfortably-perceived display system for a human XR experience.

As shown in FIG. 4A, an XR system user (60) is depicted wearing a frame (64) structure coupled to a display system (62) positioned in front of the eyes of the user. A speaker (66) is coupled to the frame (64) in the depicted configuration and positioned adjacent the ear canal of the user (in one embodiment, another speaker, not shown, is positioned adjacent the other ear canal of the user to provide for stereo/shapeable sound control). The display (62) is operatively coupled (68), such as by a wired lead or wireless connectivity, to a local processing and data module (70) which may be mounted in a variety of configurations, such as fixedly attached to the frame (64), fixedly attached to a helmet or hat (80) as shown in the embodiment of FIG. 4B, embedded in headphones, removably attached to the torso (82) of the user (60) in a backpack-style configuration as shown in the embodiment of FIG. 4C, or removably attached to the hip (84) of the user (60) in a belt-coupling style configuration as shown in the embodiment of FIG. 4D.

The local processing and data module (70) may comprise a power-efficient processor or controller, as well as digital memory, such as flash memory, both of which may be utilized to assist in the processing, caching, and storage of data a) captured from sensors which may be operatively coupled to the frame (64), such as image capture devices (such as cameras), microphones, inertial measurement units, accelerometers, compasses, GPS units, radio devices, and/or gyros; and/or b) acquired and/or processed using the remote processing module (72) and/or remote data repository (74), possibly for passage to the display (62) after such processing or retrieval. The local processing and data module (70) may be operatively coupled (76, 78), such as via a wired or wireless communication links, to the remote processing module (72) and remote data repository (74) such that these remote modules (72, 74) are operatively coupled to each other and available as resources to the local processing and data module (70).

In one embodiment, the remote processing module (72) may comprise one or more relatively powerful processors or controllers configured to analyze and process data and/or image information. In one embodiment, the remote data repository (74) may comprise a relatively large-scale digital data storage facility, which may be available through the internet or other networking configuration in a “cloud” resource configuration. In one embodiment, all data is stored and all computation is performed in the local processing and data module, allowing fully autonomous use from any remote modules.

Perceptions of Z-axis difference (i.e., distance straight out from the eye along the optical axis) may be facilitated by using a waveguide in conjunction with a variable focus optical element configuration. Image information from a display may be collimated and injected into a waveguide and distributed in a large exit pupil manner using any suitable substrate-guided optics methods known to those skilled in the art—and then variable focus optical element capability may be utilized to change the focus of the wavefront of light emerging from the waveguide and provide the eye with the perception that the light coming from the waveguide is from a particular focal distance. In other words, since the incoming light has been collimated to avoid challenges in total internal reflection waveguide configurations, it will exit in collimated fashion, requiring a viewer's eye to accommodate to the far point to bring it into focus on the retina, and naturally be interpreted as being from optical infinity—unless some other intervention causes the light to be refocused and perceived as from a different viewing distance; one suitable such intervention is a variable focus lens.

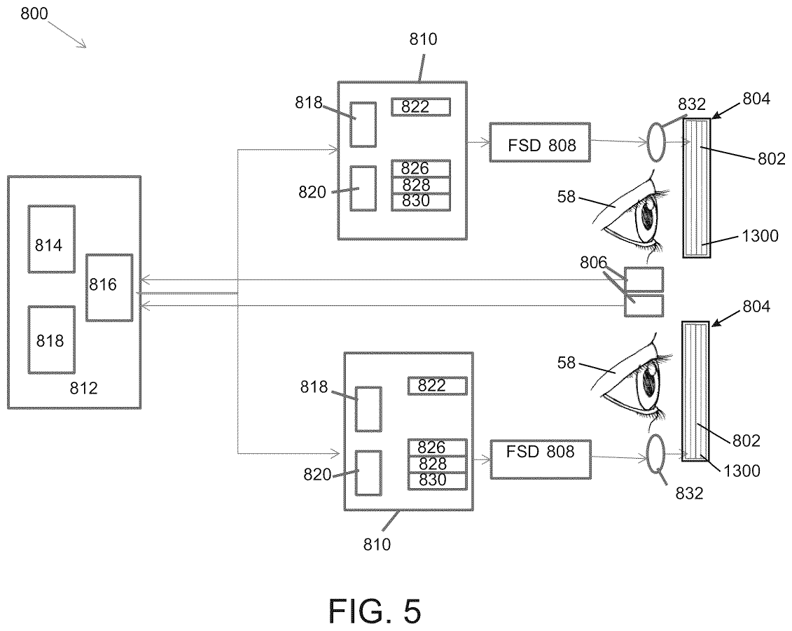

In some embodiments, collimated image information is injected into a piece of glass or other material at an angle such that it totally internally reflects and is passed into the adjacent waveguide. The waveguide may be configured so that the collimated light from the display is distributed to exit somewhat uniformly across the distribution of reflectors or diffractive features along the length of the waveguide. Upon exit toward the eye, the exiting light is passed through a variable focus lens element wherein, depending upon the controlled focus of the variable focus lens element, the light exiting the variable focus lens element and entering the eye will have various levels of focus (a collimated flat wavefront to represent optical infinity, more and more beam divergence/wavefront curvature to represent closer viewing distance relative to the eye 58 (see FIGS. 5-12).

In a “frame sequential” configuration, a stack of sequential two-dimensional images may be fed to the display sequentially to produce three-dimensional perception over time, in a manner akin to the manner in which a computed tomography system uses stacked image slices to represent a three-dimensional structure. A series of two-dimensional image slices may be presented to the eye, each at a different focal distance to the eye, and the eye/brain would integrate such a stack into a perception of a coherent three-dimensional volume. Depending upon the display type, line-by-line, or even pixel-by-pixel sequencing may be conducted to produce the perception of three-dimensional viewing. For example, with a scanned light display (such as a scanning fiber display or scanning mirror display), then the display is presenting the waveguide with one line or one pixel at a time in a sequential fashion.

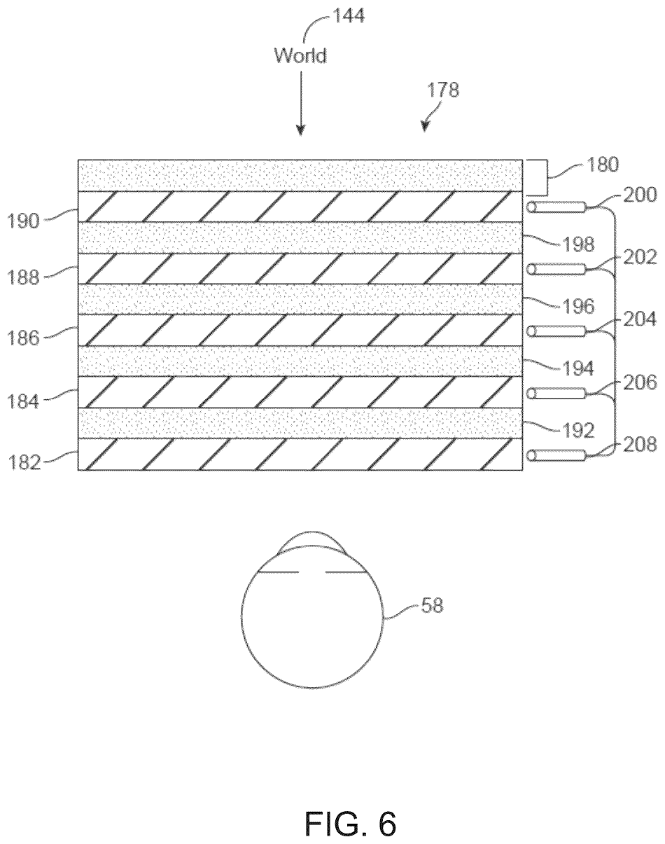

Referring to FIG. 6, a stacked waveguide assembly 178 may be utilized to provide three-dimensional perception to the eye/brain by having a plurality of waveguides 182, 184, 186, 188, 190 and a plurality of weak lenses 198, 196, 194, 192 configured together to send image information to the eye with various levels of wavefront curvature for each waveguide level indicative of focal distance to be perceived for that waveguide level. A plurality of displays (200, 202, 204, 206, 208), or in another embodiment a single multiplexed display, may be utilized to inject collimated image information into the waveguides 182, 184, 186, 188, 190, each of which may be configured, as described above, to distribute incoming light substantially equally across the length of each waveguide, for exit down toward the eye.

The waveguide 182 nearest the eye is configured to deliver collimated light, as injected into such waveguide 182), to the eye, which may be representative of the optical infinity focal plane. The next waveguide up (184) is configured to send out collimated light which passes through the first weak lens (192; e.g., a weak negative lens) before it can reach the eye (58). The first weak lens (192) may be configured to create a slight convex wavefront curvature so that the eye/brain interprets light coming from that next waveguide up (184) as coming from a first focal plane closer inward toward the person from optical infinity. Similarly, the third up waveguide (186) passes its output light through both the first (192) and second (194) lenses before reaching the eye (58). The combined optical power of the first (192) and second (194) lenses may be configured to create another incremental amount of wavefront divergence so that the eye/brain interprets light coming from that third waveguide up (186) as coming from a second focal plane even closer inward toward the person from optical infinity than was light from the next waveguide up (184).

The other waveguide layers (188, 190) and weak lenses (196, 198) are similarly configured, with the highest waveguide (190) in the stack sending its output through all of the weak lenses between it and the eye for an aggregate focal power representative of the closest focal plane to the person. To compensate for the stack of lenses (198, 196, 194, 192) when viewing/interpreting light coming from the world (144) on the other side of the stacked waveguide assembly (178), a compensating lens layer (180) is disposed at the top of the stack to compensate for the aggregate power of the lens stack (198, 196, 194, 192) below. Such a configuration provides as many perceived focal planes as there are available waveguide/lens pairings, again with a relatively large exit pupil configuration as described above. Both the reflective aspects of the waveguides and the focusing aspects of the lenses may be static (i.e., not dynamic or electro-active). In an alternative embodiment they may be dynamic using electro-active features as described above, enabling a small number of waveguides to be multiplexed in a time sequential fashion to produce a larger number of effective focal planes.

Various diffraction configurations can be employed for focusing and/or redirecting collimated beams. For example, passing a collimated beam through a linear diffraction pattern, such as a Bragg grating, will deflect, or “steer,” the beam. Passing a collimated beam through a radially symmetric diffraction pattern, or “Fresnel zone plate,” will change the focal point of the beam. A combination diffraction pattern can be employed that has both linear and radial elements produces both deflection and focusing of a collimated input beam. These deflection and focusing effects can be produced in a reflective as well as transmissive mode.

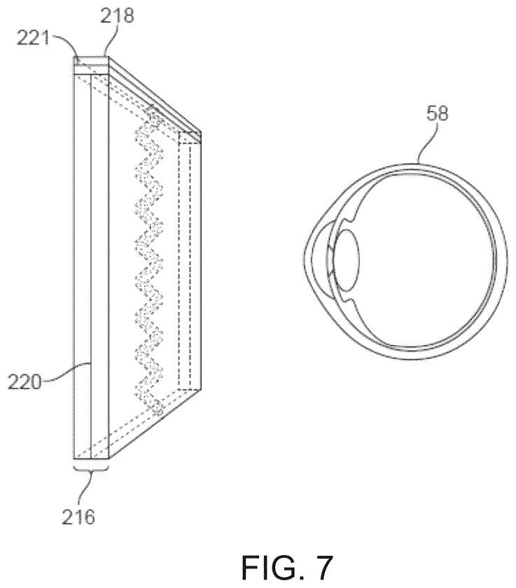

These principles may be applied with waveguide configurations to allow for additional optical system control. As shown in FIG. 7, a diffraction pattern (220), or “diffractive optical element” (or “DOE”) has been embedded within a planar waveguide (216) such that as a collimated beam is totally internally reflected along the planar waveguide (216), it intersects the diffraction pattern (220) at a multiplicity of locations. The structure may also include another waveguide (218) into which the beam may be injected (by a projector or display, for example), with a DOE (221) embedded in this other waveguide (218),

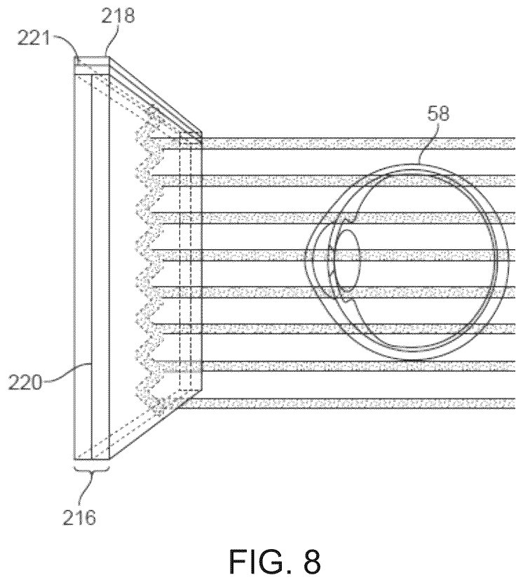

Preferably, the DOE (220) has a relatively low diffraction efficiency so that only a portion of the light of the beam is deflected toward the eye (58) with each intersection of the DOE (220) while the rest continues to move through the planar waveguide (216) via total internal reflection; the light carrying the image information is thus divided into a number of related light beams that exit the waveguide at a multiplicity of locations and the result is a fairly uniform pattern of exit emission toward the eye (58) for this particular collimated beam bouncing around within the planar waveguide (216), as shown in FIG. 8. The exit beams directed toward the eye (58) are shown in FIG. 8 as substantially parallel, because, in this case, the DOE (220) has only a linear diffraction pattern. However, changes to this linear diffraction pattern pitch may be utilized to controllably deflect the exiting parallel beams, thereby producing a scanning or tiling functionality.

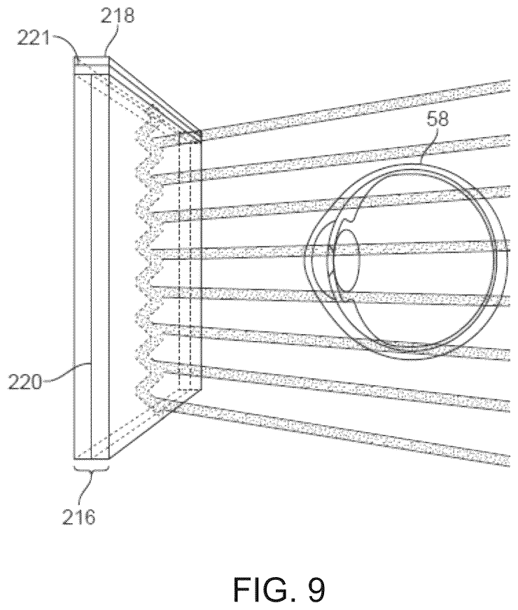

Referring to FIG. 9, with changes in the radially symmetric diffraction pattern component of the embedded DOE (220), the exit beam pattern is more divergent, which would require the eye to accommodate to a closer distance to bring it into focus on the retina and would be interpreted by the brain as light from a viewing distance closer to the eye than optical infinity.

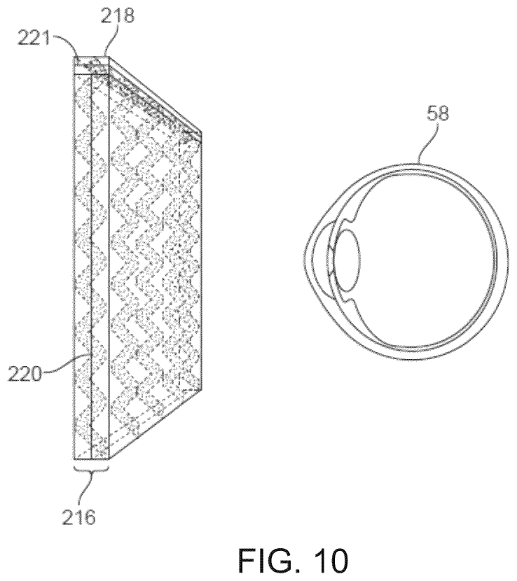

Referring to FIG. 10, with the addition of the other waveguide (218) into which the beam may be injected (by a projector or display, for example), a DOE (221) embedded in this other waveguide (218), such as a linear diffraction pattern, may function to spread the light across the entire larger planar waveguide (216), which functions to provide the eye (58) with a very large incoming field of incoming light that exits from the larger planar waveguide (216), e.g., a large eye box, in accordance with the particular DOE configurations at work.

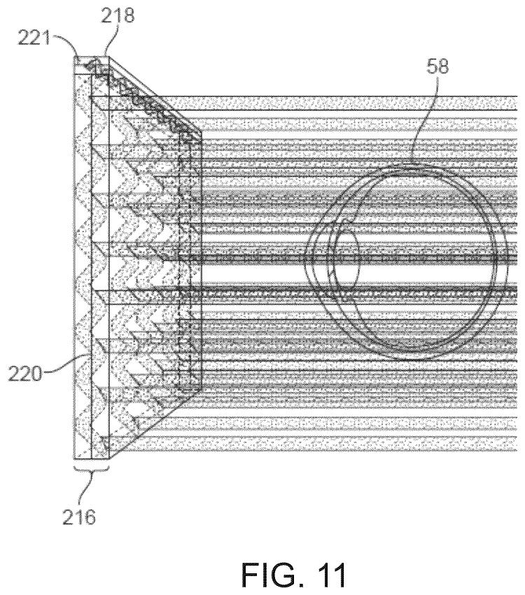

The DOEs (220, 221) are depicted bisecting the associated waveguides (216, 218) but this need not be the case; they could be placed closer to, or upon, either side of either of the waveguides (216, 218) to have the same functionality. Thus, as shown in FIG. 11, with the injection of a single collimated beam, an entire field of cloned collimated beams may be directed toward the eye (58). In addition, with a combined linear diffraction pattern/radially symmetric diffraction pattern scenario such as that discussed above, a beam distribution waveguide optic (for functionality such as exit pupil functional expansion; with a configuration such as that of FIG. 11, the exit pupil can be as large as the optical element itself, which can be a very significant advantage for user comfort and ergonomics) with Z-axis focusing capability presented, in which both the divergence angle of the cloned beams and the wavefront curvature of each beam represent light coming from a point closer than optical infinity.

In one embodiment, one or more DOEs are switchable between “on” states in which they actively diffract, and “off” states in which they do not significantly diffract. For instance, a switchable DOE may comprise a layer of polymer dispersed liquid crystal, in which microdroplets comprise a diffraction pattern in a host medium, and the refractive index of the microdroplets can be switched to substantially match the refractive index of the host material (in which case the pattern does not appreciably diffract incident light) or the microdroplet can be switched to an index that does not match that of the host medium (in which case the pattern actively diffracts incident light). Further, with dynamic changes to the diffraction terms, a beam scanning or tiling functionality may be achieved. As noted above, it is desirable to have a relatively low diffraction grating efficiency in each of the DOEs (220, 221) because it facilitates distribution of the light, and also because light coming through the waveguides that is desirably transmitted (for example, light coming from the world 144 toward the eye 58 in an augmented reality configuration) is less affected when the diffraction efficiency of the DOE that it crosses (220) is lower—so a better view of the real world through such a configuration is achieved.

Configurations such as those illustrated herein preferably are driven with injection of image information in a time sequential approach, with frame sequential driving being the most straightforward to implement. For example, an image of the sky at optical infinity may be injected at timel and the diffraction grating retaining collimation of light may be utilized. Thereafter, an image of a closer tree branch may be injected at time2 while a DOE controllably imparts a focal change, say one diopter or 1 meter away, to provide the eye/brain with the perception that the branch light information is coming from the closer focal range. This kind of paradigm can be repeated in rapid time sequential fashion such that the eye/brain perceives the input to be all part of the same image. This is just a two focal plane example—preferably the system will include more focal planes to provide a smoother transition between objects and their focal distances. This kind of configuration generally assumes that the DOE is switched at a relatively low speed (i.e., in sync with the frame-rate of the display that is injecting the images—in the range of tens to hundreds of cycles/second).

The opposite extreme may be a configuration wherein DOE elements can shift focus at tens to hundreds of MHz or greater, which facilitates switching of the focus state of the DOE elements on a pixel-by-pixel basis as the pixels are scanned into the eye (58) using a scanned light display type of approach. This is desirable because it means that the overall display frame-rate can be kept quite low; just low enough to make sure that “flicker” is not a problem (in the range of about 60-120 frames/sec).

In between these ranges, if the DOEs can be switched at KHz rates, then on a line-by-line basis the focus on each scan line may be adjusted, which may afford the user with a visible benefit in terms of temporal artifacts during an eye motion relative to the display, for example. For instance, the different focal planes in a scene may, in this manner, be interleaved, to minimize visible artifacts in response to a head motion (as is discussed in greater detail later in this disclosure). A line-by-line focus modulator may be operatively coupled to a line scan display, such as a grating light valve display, in which a linear array of pixels is swept to form an image; and may be operatively coupled to scanned light displays, such as fiber-scanned displays and mirror-scanned light displays.

A stacked configuration, similar to those of FIG. 6, may use dynamic DOEs to provide multi-planar focusing simultaneously. For example, with three simultaneous focal planes, a primary focus plane (based upon measured eye accommodation, for example) could be presented to the user, and a + margin and − margin (i.e., one focal plane closer, one farther out) could be utilized to provide a large focal range in which the user can accommodate before the planes need be updated. This increased focal range can provide a temporal advantage if the user switches to a closer or farther focus (i.e., as determined by accommodation measurement); then the new plane of focus could be made to be the middle depth of focus, with the + and − margins again ready for a fast switchover to either one while the system catches up.

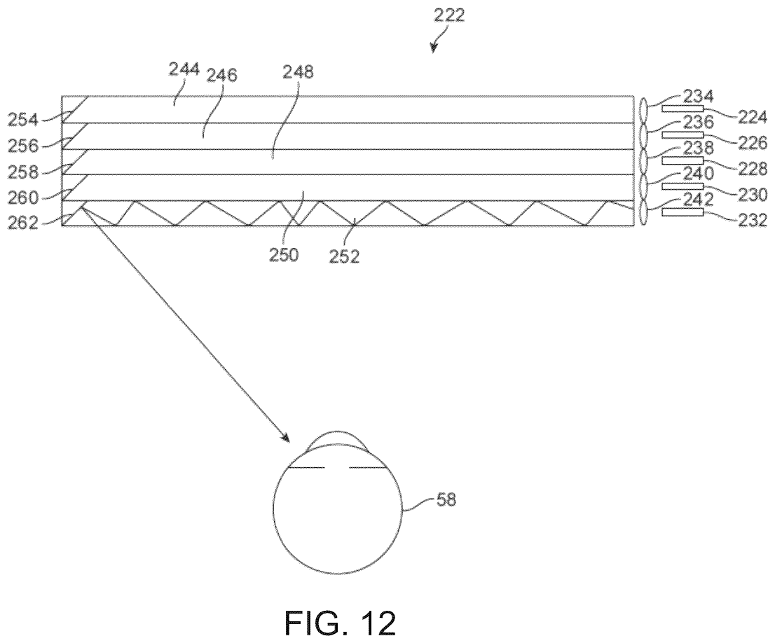

Referring to FIG. 12, a stack (222) of planar waveguides (244, 246, 248, 250, 252) is shown, each having a reflector (254, 256, 258, 260, 262) at the end and being configured such that collimated image information injected in one end by a display (224, 226, 228, 230, 232) bounces by total internal reflection down to the reflector, at which point some or all of the light is reflected out toward an eye or other target. Each of the reflectors may have slightly different angles so that they all reflect exiting light toward a common destination such as a pupil. Lenses (234, 236, 238, 240, 242) may be interposed between the displays and waveguides for beam steering and/or focusing.

As discussed above, an object at optical infinity creates a substantially planar wavefront, while an object closer, such as Im away from the eye, creates a curved wavefront (with about Im convex radius of curvature). The eye's optical system needs to have enough optical power to bend the incoming rays of light so that they end up focused on the retina (convex wavefront gets turned into concave, and then down to a focal point on the retina). These are basic functions of the eye.

In many of the embodiments described above, light directed to the eye has been treated as being part of one continuous wavefront, some subset of which would hit the pupil of the particular eye. In another approach, light directed to the eye may be effectively discretized or broken down into a plurality of beamlets or individual rays, each of which has a diameter less than about 0.5 mm and a unique propagation pathway as part of a greater aggregated wavefront that may be functionally created with an aggregation of the beamlets or rays. For example, a curved wavefront may be approximated by aggregating a plurality of discrete neighboring collimated beams, each of which is approaching the eye from an appropriate angle to represent a point of origin that matches the center of the radius of curvature of the desired aggregate wavefront.

When the beamlets have a diameter of about 0.5 mm or less, it is as though it is coming through a pinhole lens configuration, which means that each individual beamlet is always in relative focus on the retina, independent of the accommodation state of the eye—however the trajectory of each beamlet will be affected by the accommodation state. For instance, if the beamlets approach the eye in parallel, representing a discretized collimated aggregate wavefront, then an eye that is correctly accommodated to infinity will deflect the beamlets to all converge upon the same shared spot on the retina, and will appear in focus. If the eye accommodates to, say, 1 m, the beams will be converged to a spot in front of the retina, cross paths, and fall on multiple neighboring or partially overlapping spots on the retina—appearing blurred.

If the beamlets approach the eye in a diverging configuration, with a shared point of origin 1 meter from the viewer, then an accommodation of 1 m will steer the beams to a single spot on the retina, and will appear in focus; if the viewer accommodates to infinity, the beamlets will converge to a spot behind the retina, and produce multiple neighboring or partially overlapping spots on the retina, producing a blurred image. Stated more generally, the accommodation of the eye determines the degree of overlap of the spots on the retina, and a given pixel is “in focus” when all of the spots are directed to the same spot on the retina and “defocused” when the spots are offset from one another. This notion that all of the 0.5 mm diameter or less beamlets are always in focus, and that they may be aggregated to be perceived by the eyes/brain as though they are substantially the same as coherent wavefronts, may be utilized in producing configurations for comfortable three-dimensional virtual or augmented reality perception.

In other words, a set of multiple narrow beams may be used to emulate what is going on with a larger diameter variable focus beam, and if the beamlet diameters are kept to a maximum of about 0.5 mm, then they maintain a relatively static focus level, and to produce the perception of out-of-focus when desired, the beamlet angular trajectories may be selected to create an effect much like a larger out-of-focus beam (such a defocusing treatment may not be the same as a Gaussian blur treatment as for the larger beam, but will create a multimodal point spread function that may be interpreted in a similar fashion to a Gaussian blur).

In some embodiments, the beamlets are not mechanically deflected to form this aggregate focus effect, but rather the eye receives a superset of many beamlets that includes both a multiplicity of incident angles and a multiplicity of locations at which the beamlets intersect the pupil; to represent a given pixel from a particular viewing distance, a subset of beamlets from the superset that comprise the appropriate angles of incidence and points of intersection with the pupil (as if they were being emitted from the same shared point of origin in space) are turned on with matching color and intensity, to represent that aggregate wavefront, while beamlets in the superset that are inconsistent with the shared point of origin are not turned on with that color and intensity (but some of them may be turned on with some other color and intensity level to represent, e.g., a different pixel).

Referring now to FIG. 5, an example embodiment of an XR system 800 that uses an improved eyepiece having an improved diffraction structure will now be described. The XR system generally includes an image generating processor 812, at least one FSD 808 (fiber scanning device), FSD circuitry 810, a coupling optic 832, and a pair of eyepieces 804 (one for each eye 58). Each eyepiece 804 comprises an optics assembly 802 (also referred to as a “DOE assembly 802”). The DOE assembly 802 includes a plurality of stacked DOEs 1300, having a diffraction structure including a waveguide with the improved diffraction structure, as described herein. The system 800 may also include an eye-tracking subsystem 806. As shown in FIG. 5, the FSD circuitry may comprise circuitry 810 that is in communication with the image generation processor 812 having a maxim chip CPU 818, a temperature sensor 820, a piezo-electrical drive/transducer 822, a red laser 826, a blue laser 828, and a green laser 830 and a fiber combiner that combines all three lasers 826, 828 and 830. It is noted that other types of imaging technologies are also usable instead of FSD devices. For example, high-resolution liquid crystal display (“LCD”) systems, a backlighted ferroelectric panel display, and/or a higher-frequency DLP system may all be used in some embodiments of the invention.

The image generating processor 812 is responsible for generating virtual content to be ultimately displayed to the user. The image generating processor 812 may convert an image or video associated with the virtual content to a format that can be projected to the user in 3D. For example, in generating 3D content, the virtual content may need to be formatted such that portions of a particular image are displayed on a particular depth plane while other are displayed at other depth planes. Or, all of the image may be generated at a particular depth plane. Or, the image generating processor may be programmed to feed slightly different images to right and left eye such that when viewed together, the virtual content appears coherent and comfortable to the user's eyes. In one or more embodiments, the image generating processor 812 delivers virtual content to the optics assembly in a time-sequential manner. A first portion of a virtual scene may be delivered first, such that the optics assembly projects the first portion at a first depth plane. Then, the image generating processor 812 may deliver another portion of the same virtual scene such that the optics assembly projects the second portion at a second depth plane and so on. Here, the Alvarez lens assembly may be laterally translated quickly enough to produce multiple lateral translations (corresponding to multiple depth planes) on a frame-to frame basis.

The image generating processor 812 may further include a memory 814, a CPU 818, a GPU 816, and other circuitry for image generation and processing. The image generating processor 812 may be programmed with the desired virtual content to be presented to the user of the AR system. It should be appreciated that in some embodiments, the image generating processor may be housed in the wearable XR system. In other embodiments, the image generating processor and other circuitry may be housed in a belt pack that is coupled to the wearable optics.

The XR system 800 also includes coupling optics 832 to direct the light from the FSD to the optics assembly 802. The coupling optics 832 may refer to one or more conventional lenses that are used to direct the light into the DOE assembly. The XR system 800 also includes the eye-tracking subsystem 806 that is configured to track the user's eyes and determine the user's focus.

In one or more embodiments, software blurring may be used to induce blurring as part of a virtual scene. A blurring module may be part of the processing circuitry in one or more embodiments. The blurring module may blur portions of one or more frames of image data being fed into the DOE. In such an embodiment, the blurring module may blur out parts of the frame that are not meant to be rendered at a particular depth frame. Example approaches that can be used to implement the above image display systems, and components therein, are described in U.S. Utility patent application Ser. No. 14/555,585 filed on Nov. 27, 2014, which is incorporated by reference herein in its entirety.

### Improved Diffraction Structure

As stated above, a diffraction pattern can be formed onto a planar waveguide, such that as a collimated beam is totally internally reflected along the planar waveguide, the beam intersects the diffraction pattern at a multiplicity of locations. This arrangement can be stacked to provide image objects at multiple focal planes within a stereoscopic 3-D simulation display system according to some embodiments of the invention.

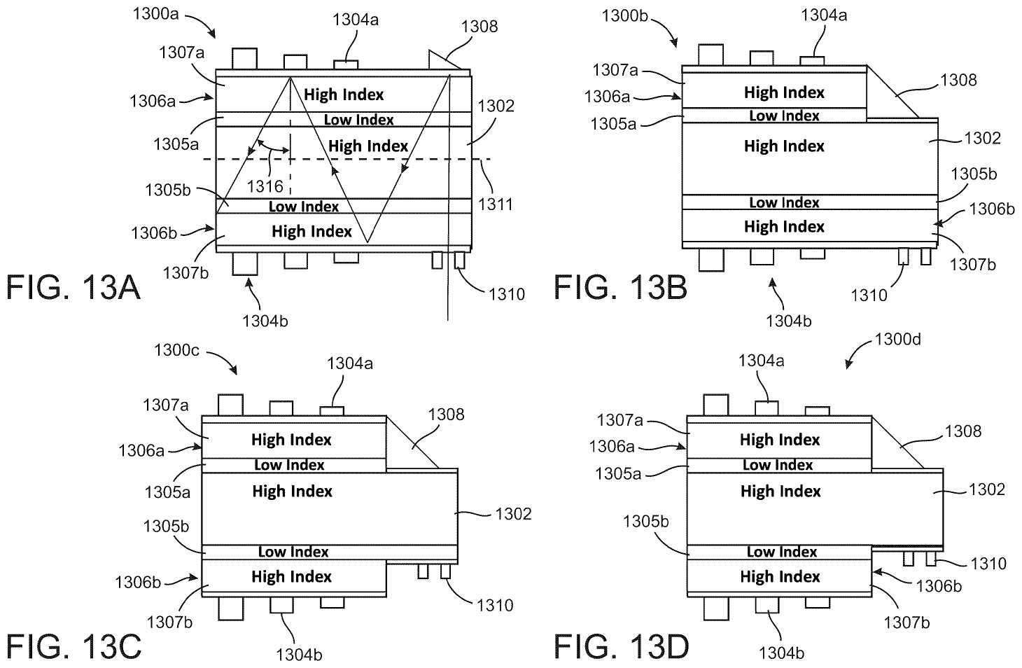

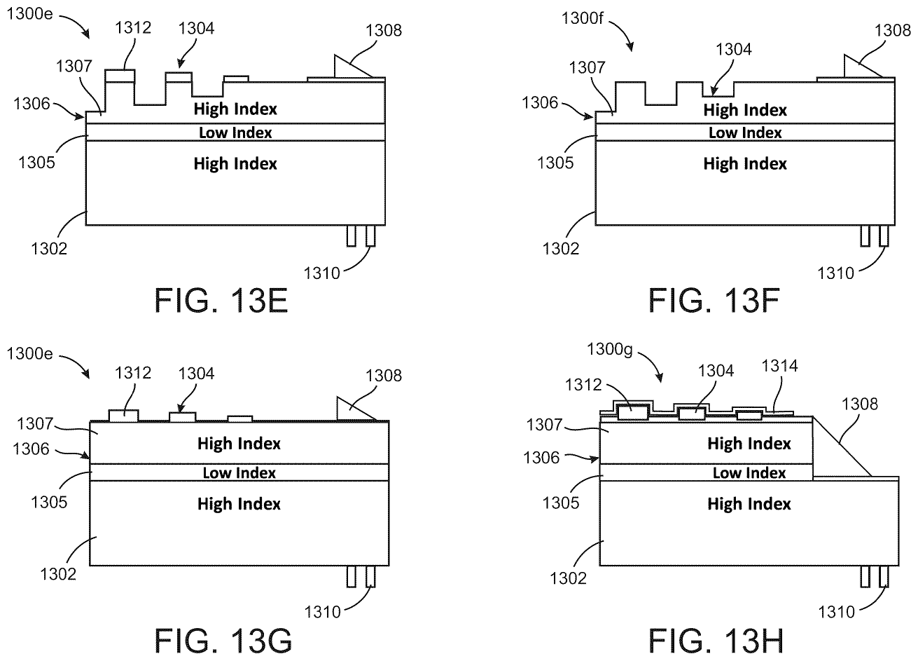

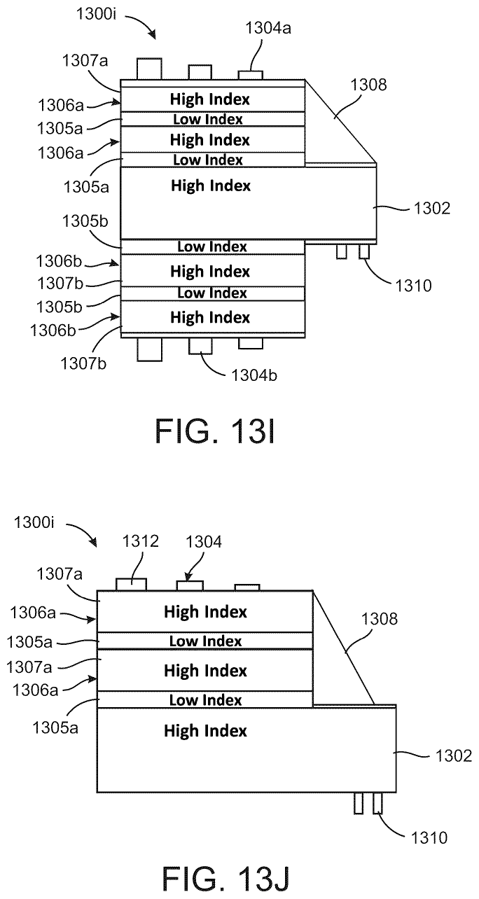

FIGS. 13A-13H illustrate several exemplary embodiments of diffraction structures 1300 for a DOE 804 which utilize the optical layer pair to improve the performance of the eyepiece of an XR display system 800. The different embodiments of FIGS. 13A-13H have various configurations of the surface grating(s) 1304, input coupling grating 1310 (also referred to as “ICG” or “incoupling grating”), first reflector element 1308 and the optical layer pair(s) 1306 relative to each other and the waveguide substrate 1302, as described herein. For example, the embodiments of FIGS. 13A-13D (“double side”) have surface gratings 1304 and optical layer pair(s) 1306 on both sides of the waveguide substrate 1302, while the embodiments of FIGS. 13E-13H (“single side”) have surface gratings 1304 and optical layer pair(s) 1306 on only a first side of the waveguide substrate 1302.

FIG. 13A depicts a diffraction structure 1300a (i.e., a DOE 804) in which the surface grating 1304, input coupling grating 1310 and first reflector element 1308 are all disposed (e.g., formed, deposited or placed) on a surface of one of the optical layer pairs 1306. The diffraction structure 1300a includes a waveguide substrate 1302 (also referred to herein as a “light guide”, “substrate”, or “waveguide substrate”). The waveguide substrate 1302 has a high refractive index relative to the low refractive elements of the diffraction structures 1300a. For instance, the waveguide substrate 1302 may be formed of TAFD55 glass which has refractive index of about 2.0.

A top optical layer pair 1306a (also referred to as a “first optical layer pair 1306a) is disposed on a first side of the waveguide substrate 1302 (a top side in the orientation of the waveguide substrate 1302 shown in FIG. 13A), and a bottom optical layer pair 1306b (also referred to as a “second optical layer pair 1306b”) is disposed on a second side of the waveguide substrate 1302 (a bottom side in the orientation of the waveguide substrate 1302 shown in FIG. 13A). As used herein, terms “top” and “bottom” on are only used to distinguish elements from each other and provide reference for their relative position and do not refer to the vertical relationship or orientation of any elements of the present invention. Although only one top optical layer pair 1306a is shown for the diffraction structure 1300a, additional top optical layer pairs 1306a may be stacked on the first optical layer pair 1306a, such as a second top optical layer pair 1306a, etc. Similarly, only one bottom optical layer pair 1306b is shown for the diffraction structure 1300a, but additional bottom optical layer pairs 1306b may be stacked on the top optical layer pair 1306b, such as a second bottom optical layer pair 1306b, etc. For example, FIG. 13I depicts a diffraction structure 1300i having two top optical layer pairs 1306a stacked on each other, and two bottom optical layer pairs 1306b stacked on each other. In other embodiments, there may be a different number of stacked optical layer pairs 1306 on the top than on the bottom of the waveguide substrate 1302 (e.g., one top optical layer pair 1306a, and two bottom optical layer pairs 1306b). Indeed, any of the example embodiments of diffraction structures 1300 depicted in FIGS. 13A-13G may have multiple optical layer pairs 1306 stacked on each other. As another example, FIG. 13J illustrates a singled sided diffraction structure 1300j having multiple optical layer pairs 1306a, in this case two optical layer pairs 1306a.

Each optical layer pair 1306a, 1036b includes a low index layer 1305a, 1035b, and a high index layer 1307a, 1307b disposed directly on an exterior side of the low index layer 1305. As defined above, the terms “interior” and “exterior” are relative to a plane 1311 through a middle of a thickness of the waveguide substrate 1302, wherein the plane 1311 is the interior most position. In other words, an element is “interior” to another element if it is closer to the plane 1311. The high index layer 1307 has a higher refractive index than the low index layer 1305. The relative refractive indexes of the high index layer 1307 and low index layer 1305 are tuned to improve the uniformity of the certain colors of the diffraction efficiency selectively for certain colors, increasing the magnitude and uniformity of the diffraction efficiency of the eyepiece, increasing the (CPE) efficiency of the eyepiece, and/or increasing the input coupling grating (ICG) launch efficiency of the eyepiece. The optical layer pair(s) 1306 may be disposed directly on the surface of the waveguide substrate 1302, or there may be one or more intermediate layers (as described herein, and also referred to herein as an “underlayer”) disposed between the optical layer pair(s) 1306 and the waveguide substrate 1302.

As shown in FIG. 13A, the input coupling grating 1306 is disposed on the exterior surface of the first optical layer pair 1306a. The diffraction structure 1300a has a top surface grating 1304a disposed on the exterior surface of the top optical layer pair 1306a on the first side of the waveguide substrate 1302, and a bottom surface grating 1304b disposed on the exterior surface of the bottom optical layer pair 1306b on the second side of the waveguide substrate 1302. Hence, the top optical layer pair 1306a is disposed between the waveguide substrate 1302 and the top surface grating 1304a, and the bottom optical layer pair 1306b is disposed between the waveguide substrate 1302 and the bottom surface grating 1304b. The top surface grating 1304a and bottom surface grating 1304b have a low refractive index relative to the high refractive index elements. As some non-limiting examples, the diffraction gratings 1304 may be formed of KT21 material, or the like. KT21 has a refractive index of about 1.5.

A first reflector element 1308 is disposed on the exterior surface of the top optical layer pair 1306a. A surface input coupling grating 1306 is disposed on the exterior surface of the second optical layer pair 1306a. The light beam 1310 illustrates an example of the path of an input light beam as the light is processed by the diffraction structure 1300a to provide image objects at multiple focal planes within a stereoscopic 3-D simulation display system. The angle of incidence 1316 of the light beam as it travels through the diffraction structure 1300 is also shown in FIG. 13A.

Turning to FIG. 13B, the diffraction structure 1300b is the same as the diffraction structure 1300a, except that the first reflector element 1308 is disposed on the surface of the first side (i.e., the top surface) of the waveguide substrate 1302.

FIG. 13C illustrates a diffraction structure 1300c that is the same as the diffraction structure 1300b, except that the ICG 1310 is disposed on the exterior surface of the low index layer 1305b of the bottom optical layer pair 1306b.

The diffraction structure 1300d, shown in FIG. 13D, is the same as the diffraction structure 1300b, except that the ICG 1310 is disposed directly on the bottom surface of the waveguide substrate 1302. Indeed, this configuration of the ICG 1310 disposed directly on the surface of the waveguide substrate 1302, without any of the optical layers of the optical layer pair between the ICG 1310 and the waveguide substrate 1302, may be used in all of the embodiments shown in FIGS. 13A-1313H because the intervening layers can degrade the performance of the DOE 1300.

Referring to FIG. 13E, the diffraction structure 1300e is similar to the diffraction structure 1300a, except that it has the optical layer pair(s) 1306 and the surface grating 1304 on only the top side of the waveguide substrate 1302. Accordingly, the ICG 1310 is disposed directly on the bottom surface of the waveguide substrate 1302. Also, the surface grating 1304 is formed both by grating etched into the high index layer 1307 of the top optical layer pair 1306 and an overcoat 1312 (which may be a low index layer).

Turning to FIG. 13F, the diffraction structure 1300f is the same as the diffraction structure 1300e, except that the surface grating 1304a is formed only by etching into the high index layer 1307a of the top optical layer pair 1306a.

The diffraction structure 1300g, shown in FIG. 13G, is the same as the diffraction structure 1300a, except that the surface grating 1304a is formed only in a low index overcoat 1312 on the top side of the waveguide substrate 1302.

As illustrated in FIG. 13H, the diffraction structure 1300h is the same as the diffraction structure 1300g, except that the diffraction structure 1300g also includes a high index layer 1314 (e.g., a top surface layer or coating) on top of the surface grating 1304a. The high index layer 1314 on top of the surface grating 1304 may be added to any of the embodiments 1300a-1300f.

As explained herein, the addition of the optical layer pair(s) 1306 between the surface grating 1304 and the waveguide substrate 1302 improves the performance of the eyepiece. The added optical layer pair(s) 1306 provide an added degree of freedom to adjust the diffraction efficiency vs. the angle of incidence and the wavelength behavior. This effect is likely the result of a combination of thin film interference effects, and changing the direction of the light via Snell's law when the light is incident on the surface grating 1304. The ability to adjust the diffraction efficiency vs. the angle of incidence and wavelength potentially allows the following:
a. tuning the diffraction efficiency selectively for certain colors in a single substrate eyepiece, in which all colors (e.g., three primary colors) share a single waveguide and propagate in different angular ranges of the angle of incidence 1316, leading to better color uniformity; and
b. improving the uniformity over the field of view by better matching the diffraction efficiency to the bounce spacing (outcoupled beam density) and also the ICG launch efficiency, which is also dependent on the angle of incidence 1316.

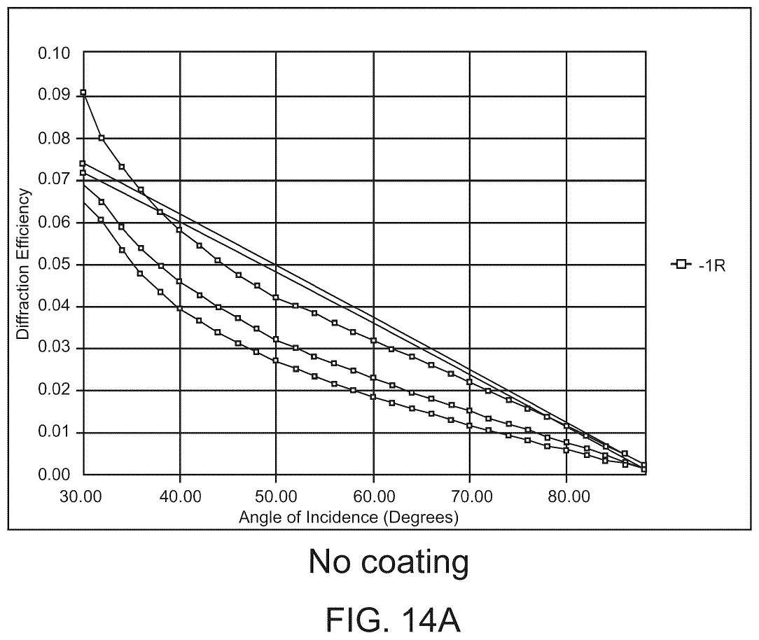

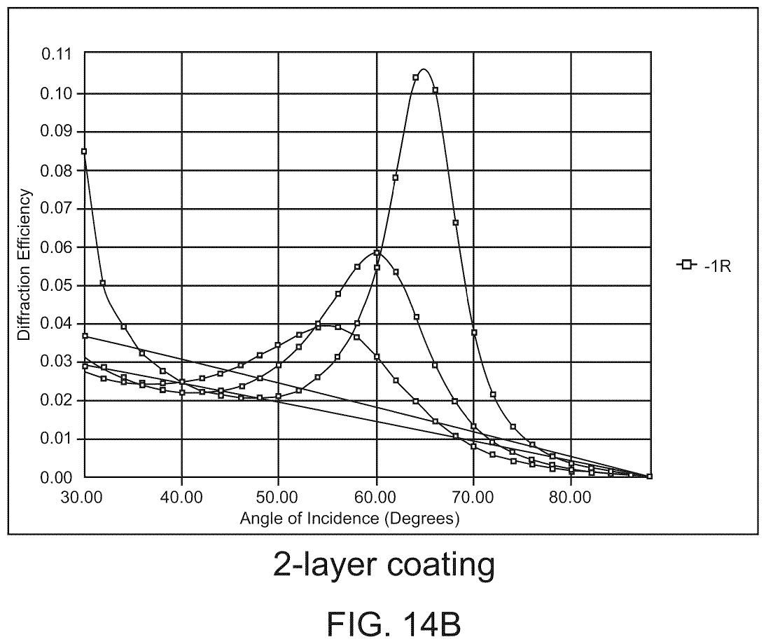

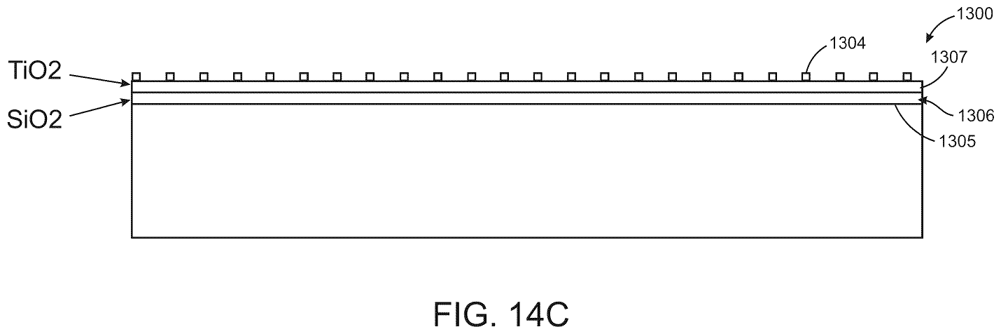

Turning to FIGS. 14A and 14B, the respective graphs show the diffraction efficiency vs. angle of incidence for a square diffraction structure having a square groove surface grating on glass without the optical layer pair 1306 (FIG. 14A) compared to a diffraction structure with a single optical layer pair 1306 (FIG. 14B). The diffraction structure 1300 with the single optical layer pair 1306 is schematically illustrated in FIG. 14C. The diffraction structure in FIG. 14C includes an optical layer pair 1306 having a low index layer 1305 comprising a coating/film of SiO₂ and a high index layer 1306 comprising a coating/film of TiO₂. The graphs of FIGS. 14A and 14B illustrate that the diffraction efficiency of the diffraction structure 1300 with the optical layer pair 1306 increases at higher incident angles 1316, wherein the bounce spacing decreases, helping compensate for the lower outcoupled power.

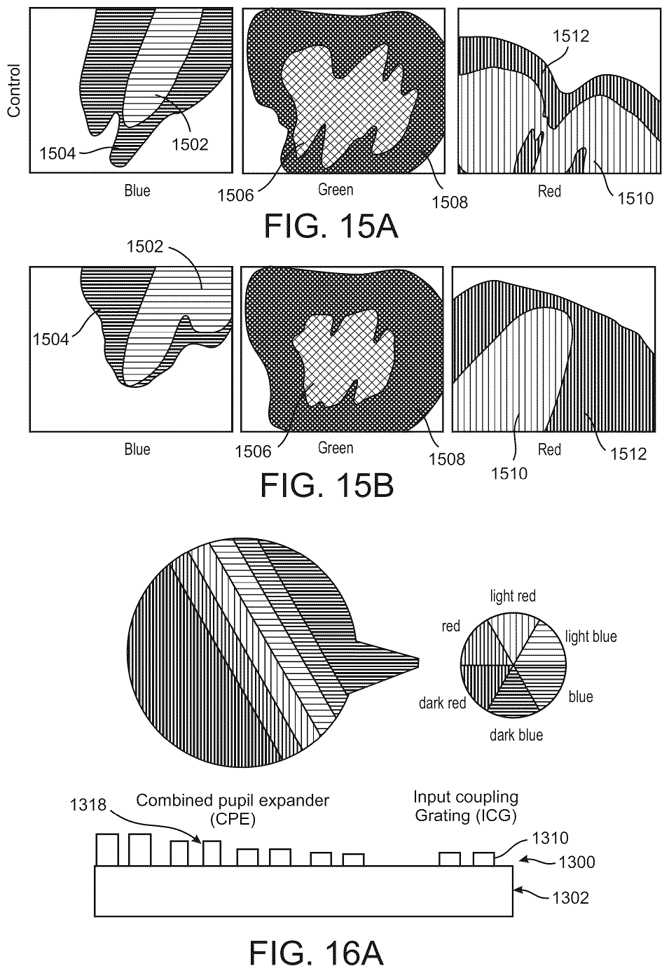

FIGS. 15A and 15B show a comparison of the response of a single diffraction structure in three primary colors (red, blue, green, RGB) with (FIG. 15B) and without (FIG. 15A) the use of the optical layer pair 1306. The diffraction structure used for the images of FIG. 15B comprised a 2-sided surface grating imprint with a honeycomb architecture, a waveguide substrate formed of TAFD55 glass and coated with an optical layer pair 1306 under the imprinted gratings. The optical layer pair 1306 included a high index layer 1307 comprising 100 nm thick layer of TiO₂, and the low index layer 1305 comprising a 10 nm thick layer of SiO₂. As shown in FIGS. 15A, the blue light has a brightest blue area 1502 and less bright blue are 1504, the green light has a brightest green area 1506 and a less bright green area 1508, and the red light has a brightest red area 1510 and a less bright red area 1512. FIG. 15

The goal in the color response is to get maximal overlap of all three colors. As shown in FIGS. 15A and 15B, this occurs near the center. Red and blue typically show on opposite sides of the field of view. Extending either of those colors toward the center will help give a larger area in which there is decent color overlap and the potential to get a decent color image. As can be seen by comparing FIGS. 15A and 15B, the use of the optical layer pair 1306 extends the red in the center of the image, which this particular optical layer pair 1306 was designed to enhance. In FIG. 15B, red is present in over ¾ of the image in the eyepiece with the optical layer pair 1306 coatings, whereas in FIG. 15A without the optical layer pair 1306, red is present in only roughly one-half of the image. Generally, higher index coatings, and combinations of multiple index coatings will yield larger and more complex swings in diffraction efficiency. For a three-layer eyepiece stack in which each layer is optimized separately for red, green, blue wavelengths, the addition of optical layer pairs 1306 coating influences the diffraction efficiency as noted above which in turn also affects the overall optical performance, as further explained below.

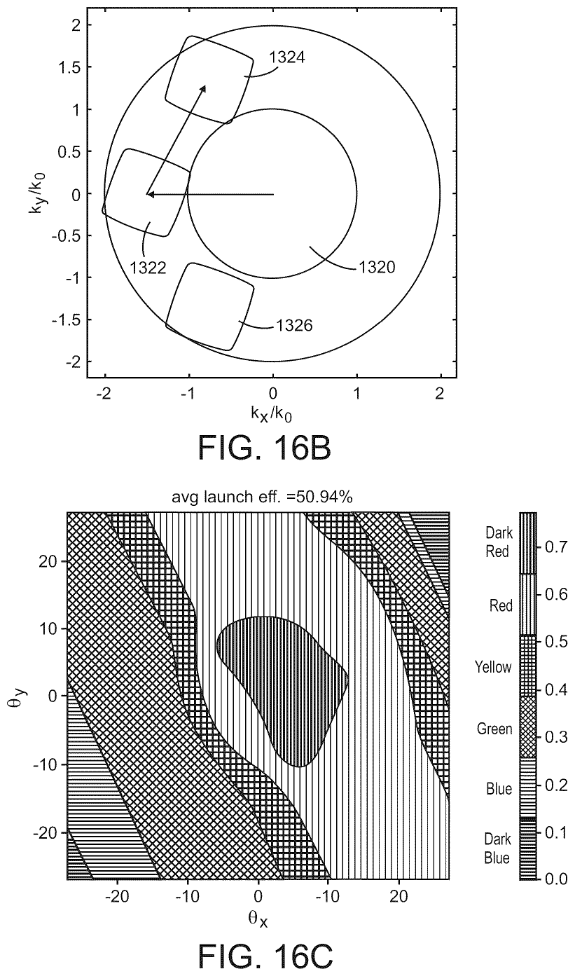

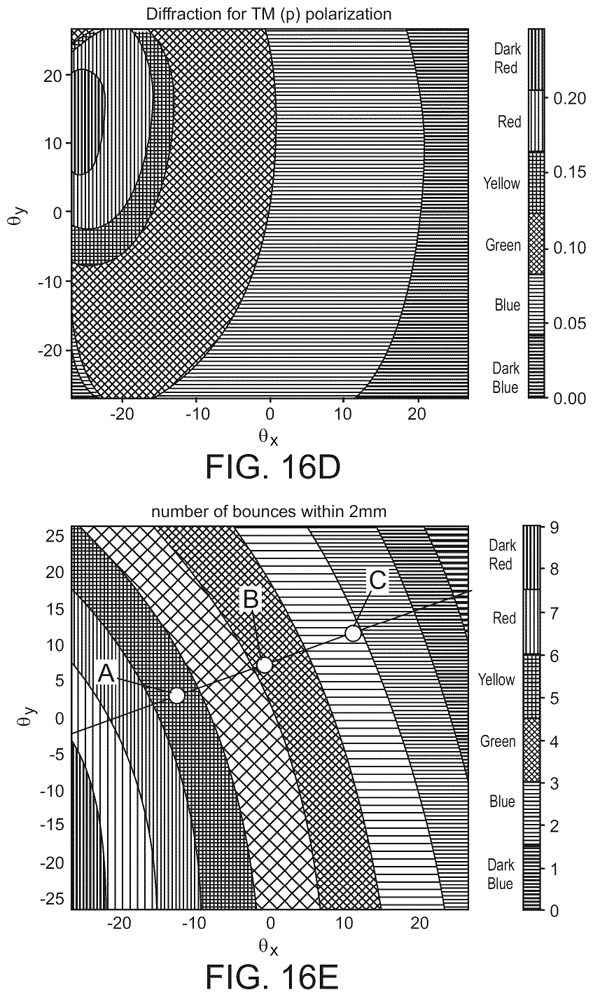

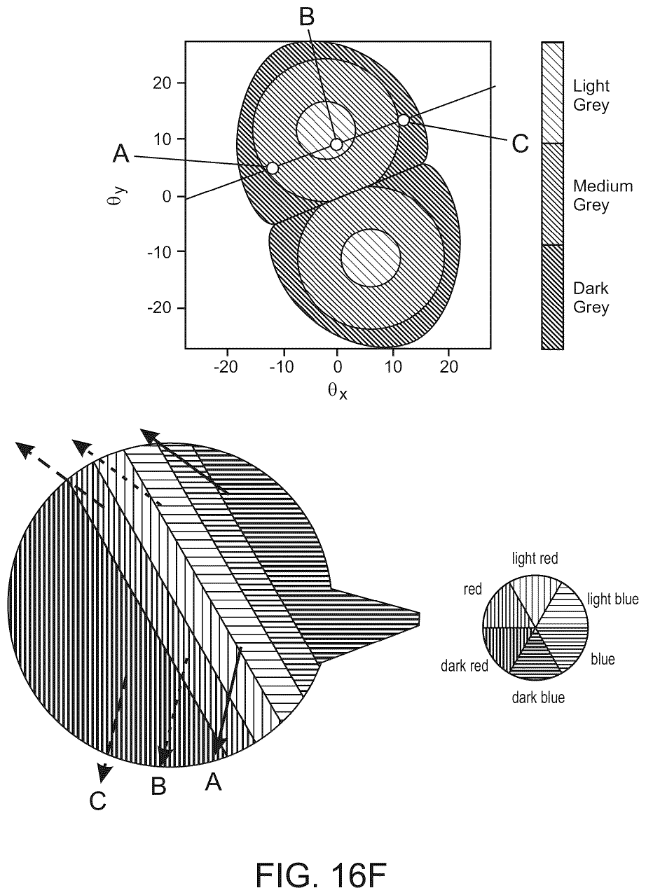

FIG. 16A schematically shows a substrate structure 1300 having an ICG 1310 and a CPE 1318. The CPE 1318 are grating structures of variable heights, as depicted in FIG. 16A. The display engine (e.g., a projector) couples the light into the waveguide substrate 1302 via the ICG 1310. For example, the display engine may be a liquid crystal on silicon (LCOS) display. Each LCOS pixel is mapped to a specific angle of incidence at the ICG 1310 location.

FIG. 16B is a momentum space diagram of the substrate structure 1300 of FIG. 16A in which each angle of incidence is mapped to the momentum of light indicated by the right box 1320. The light inside the waveguide propagating towards the CPE 1318 consists of light rays whose momentum is shifted by the ICG grating vector (2×/lattice period). The corresponding momentum of in-coupled light lie inside the left box 1322. All these light rays interact with the grating region in the CPE 1318 undergoing appropriate shifts in the momentum space (top box 1324 and bottom box 1326). The CPE grating 1318 is designed to spread the light as well as to outcouple it. FIG. 16C shows a typical example of launch efficiency as a function of angle of incidence for the substrate structure 1300. The diffraction efficiency for s-polarized light undergoing the illustrated CPE diffraction in FIG. 16B is demonstrated in FIG. 16D. As evident in FIGS. 16C and 16D, both launch efficiency and diffraction efficiency of the grating are highly nonuniform as a function of angle of incidence or momentum of light and consequently, display pixels. One more factor that adds to the nonuniformity is the nonuniformity in the amount of interaction of light rays within the waveguide 1302 with the diffraction grating 1304. For light rays inside the waveguide of momentum outlines by the left box 1322 in FIG. 16B, the number of hits with the surface grating 1304 for a propagation distance of 2 mm is depicted in FIG. 16E. It follows that the light rays corresponding to the left portion of the field of view interact strongly compared to those corresponding to the right portion of the field of view. As a result, within the CPE 1318 region, the position of strongest emission coming from a specific display pixel varies a lot resulting in a nonuniform distribution of light emission at a given location. This is schematically shown in FIG. 16F, along with the simulated light distribution at the center of the CPE 1318. Ideally, the distribution shown in the top schematic should be uniform over all the field of view.

Ideally, the distribution shown in the top schematic should be uniform over all the field of view.

In order to capture the role of diffraction efficiency, the CPE efficiency over the field of view is defined as a multiplication (normalized by a suitable factor) of diffraction efficiency, number of hits with the grating, and ICG launch efficiency. This quantification is set forth by the equation below:
CPE_{efficiency (θx, θy)}=Diffraction efficiency×(no. of hits within 2 mm)/10×ICG launch efficiency

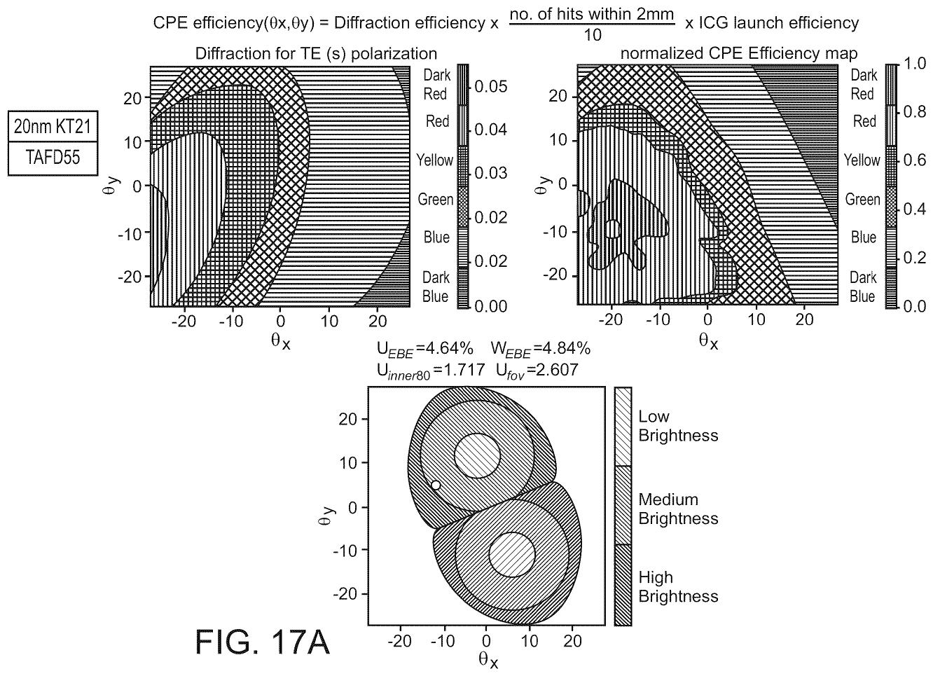

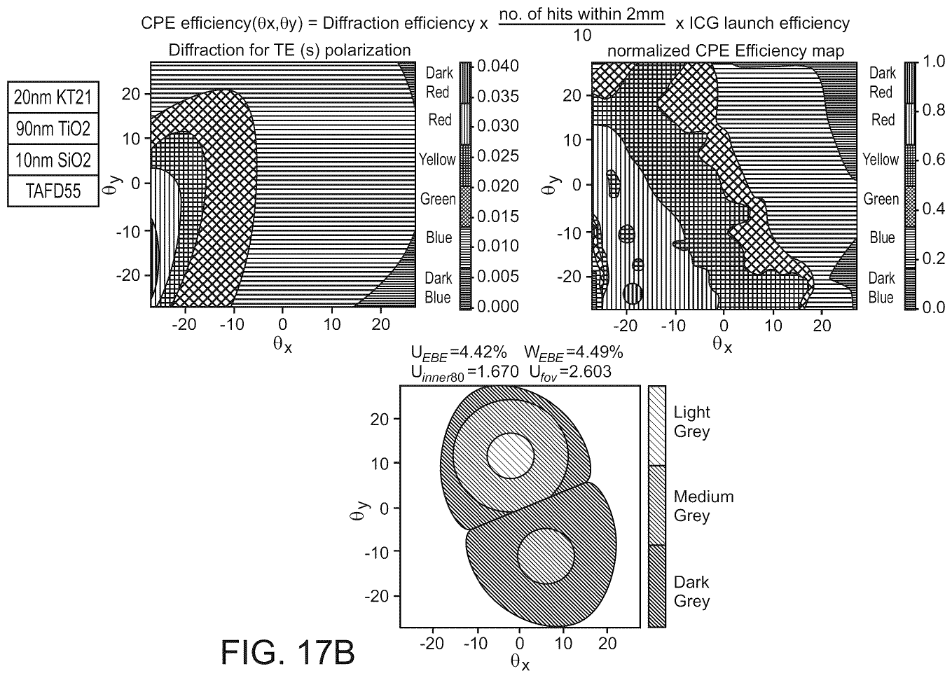

FIGS. 17A and 17B illustrate a comparison of the uniformity of diffraction efficiency for a diffraction structure without the optical layer pair 1306 (FIG. 17A) compared to a diffraction structure 1300 with a single optical layer pair 1306 (FIG. 17B). FIG. 17A corresponds to a single layer design consisting of TAFD55 glass waveguide substrate 1302 and a surface grating 1304 of a 20 nm thick layer of KT21 material. FIG. 17B corresponds to a design same as for FIG. 17B, but with the addition of a single optical pair 1306 having a high index layer 1307 comprising a 90 nm thick layer of TiO₂ and a low index layer 1305 comprising a 10 nm thick layer SiO₂ inserted between the waveguide substrate 1302 and the surface grating layer 1304. In both FIG. 17A and 17B, the left 2d plot illustrates the diffraction efficiency variation, the middle 2d plot shows the CPE efficiency defined above, and the right 2d plot shows the normalized emitted distribution within a square box of 4 mm located at the center of the CPE. The simulations were performed using in-house ray-tracing software.

For an ideal uniform light emission near the CPE center (where the human eye will be located), the CPE efficiency should be uniform over the field of view. Diffraction efficiency engineering by the addition of the optical layer pair 1306 reduces the CPE efficiency nonuniformity, as indicated by the middle 2d plots of FIGS. 17A and 17B. The uniformity gain is noticed via full ray-tracing simulations. The uniformity is characterized by the typical 8020 uniformity (difference between 80th percentile and 20th percentile values divided by the media 50th percentile value) over the inner 80% of the field of view. The lower value of 8020 uniformity score implies better uniformity. While this is one example, additional optimization based on different combinations of coatings and overcoatings can be performed to optimize CPE efficiency uniformity and consequently the uniformity of extended reality (XR) waveguide display over the field of view.

In addition to the architectures presented above in FIGS. 13A-13G, 14C, and 16, which are possible with a pattern in organic material over the high index layer 1305 using photolithography or imprint lithography with ultra-thin RLT (˜20 nm such as using ML's J-FILTM), the architectures should perform similarly to the angles in consideration when:
1) The high index gratings can be etched (reactive ion etching “RIE”, inductively coupled plasma etching “ICP”, ion beam etching “IBE”, etc.) in using the pattern definition from the organic layer;
2) A high index layer can be further deposited over the organic pattern using PVD (Sputter, Evaporation) or “CVD” (low-pressure plasma-enhanced CVD “LPPECVD”, atomic layer deposition “ALD”, “atmospheric-pressure plasma-enhanced” APPECVD) processes which then defines a pattern to the overcoat high index layer;
3) A 2nd lower index layer can be deposited on top of the 1st high index layer (which is over the 1st low index layer) which is etched into (RIE, ICP, IBE) using a patterned resist;
4) Similarly the 2nd lower index layer with a pattern can get a high index over coat using PVD (Sputter, Evaporation) or CVD (PPPECVD, ALD, APPECVD) process which defines a high index pattern.

The high index layer 1307 may be a film or coating applied as described herein. The high index layer 1307 can comprise various inorganic materials such as Si₃N₄, ZrO₂, TiO₂, SiC, ZnTe, GP, BP and/or similar materials which have a high index of refraction (greater than 1.7), and low absorption (k<0.001) type materials which have a high index of refraction greater than 1.7, and a low absorption (k<0.001). The high index layer 1307 can also comprise any suitable organic filler based materials such as organic UV and/or Thermal curable resin composite composed of Sulphur, aromatic groups (which maintain a high index of the polymer base material >1.6) and high index Nanoparticles (e.g. ZrO₂, TiO₂) with a functional surface to prevent particle agglomeration and maintain uniform particle dispersity in the composite resin solution (this can lead to internal scatter for light in TIR over uniformly homogenous high index films).

The low index layer 1305 may also be a film or coating applied as described herein. The low index layer 1305 can comprise, without limitation, any suitable inorganic material such as MgF, SiO₂, etc. as well as organic materials such as normal UV and thermal curable resins which are usually around a refractive index of about 1.53, as well as Teflon type material which have a refractive index of about 1.3. A solgel type approach may be used to make porous materials where the refractive index can reach 1.1˜1.2 (this can lead to internal scatter for light in TIR over uniformly homogenous low index films). As illustrated in FIGS. 13A-13G, the surface gratings 1304 pattern, and optical layer pair(s) 1306 for a diffraction structure 1300 may be on same side, opposite sides or both sides of the waveguide substrate 1302.

The diffractions structures 1300 disclosed herein may be manufactured using any suitable manufacturing techniques. Certain high-refractive index polymers such as one known as “MR 174” may be directly embossed, printed, or etched to produce desired patterned structures, although there may be challenges related to cure shrinkage and the like of such layers. Thus, in another embodiment, another material may be imprinted, embossed, or etched upon a high-refractive index polymer layer (i.e., such as a layer of MR 174) to produce a functionally similar result. Current state of the art printing, etching (i.e., which may include resist removal and patterning steps similar to those utilized in conventional semiconductor processes), and embossing techniques may be utilized and/or combined to accomplish such printing, embossing, and/or etching steps. Molding techniques, similar to those utilized, for example, in the production of DVDs, may also be utilized for certain replication steps. Further, certain jetting or deposition techniques utilized in printing and other deposition processes may also be utilized for depositing certain layers with precision.

In the foregoing specification, the invention has been described with reference to specific embodiments thereof. It will, however, be evident that various modifications and changes may be made thereto without departing from the broader spirit and scope of the invention. For example, the above-described process flows are described with reference to a particular ordering of process actions. However, the ordering of many of the described process actions may be changed without affecting the scope or operation of the invention. The specification and drawings are, accordingly, to be regarded in an illustrative rather than restrictive sense.

Various example embodiments of the invention are described herein. Reference is made to these examples in a non-limiting sense. They are provided to illustrate more broadly applicable aspects of the invention. Various changes may be made to the invention described and equivalents may be substituted without departing from the true spirit and scope of the invention. In addition, many modifications may be made to adapt a particular situation, material, composition of matter, process, process act(s) or step(s) to the objective(s), spirit or scope of the present invention. Further, as will be appreciated by those with skill in the art that each of the individual variations described and illustrated herein has discrete components and features which may be readily separated from or combined with the features of any of the other several embodiments without departing from the scope or spirit of the present inventions. All such modifications are intended to be within the scope of claims associated with this disclosure.

The invention includes methods that may be performed using the subject devices. The methods may comprise the act of providing such a suitable device. Such provision may be performed by the end user. In other words, the “providing” act merely requires the end user obtain, access, approach, position, set-up, activate, power-up or otherwise act to provide the requisite device in the subject method. Methods recited herein may be carried out in any order of the recited events which is logically possible, as well as in the recited order of events.

Example aspects of the invention, together with details regarding material selection and manufacture have been set forth above. As for other details of the present invention, these may be appreciated in connection with the above-referenced patents and publications as well as generally known or appreciated by those with skill in the art. The same may hold true with respect to method-based aspects of the invention in terms of additional acts as commonly or logically employed.

In addition, though the invention has been described in reference to several examples optionally incorporating various features, the invention is not to be limited to that which is described or indicated as contemplated with respect to each variation of the invention. Various changes may be made to the invention described and equivalents (whether recited herein or not included for the sake of some brevity) may be substituted without departing from the true spirit and scope of the invention. In addition, where a range of values is provided, it is understood that every intervening value, between the upper and lower limit of that range and any other stated or intervening value in that stated range, is encompassed within the invention.

Also, it is contemplated that any optional feature of the inventive variations described may be set forth and claimed independently, or in combination with any one or more of the features described herein. Reference to a singular item, includes the possibility that there are plural of the same items present. More specifically, as used herein and in claims associated hereto, the singular forms “a,” “an,” “said,” and “the” include plural referents unless the specifically stated otherwise. In other words, use of the articles allow for “at least one” of the subject item in the description above as well as claims associated with this disclosure. It is further noted that such claims may be drafted to exclude any optional element. As such, this statement is intended to serve as antecedent basis for use of such exclusive terminology as “solely,” “only” and the like in connection with the recitation of claim elements, or use of a “negative” limitation.

Without the use of such exclusive terminology, the term “comprising” in claims associated with this disclosure shall allow for the inclusion of any additional element—irrespective of whether a given number of elements are enumerated in such claims, or the addition of a feature could be regarded as transforming the nature of an element set forth in such claims. Except as specifically defined herein, all technical and scientific terms used herein are to be given as broad a commonly understood meaning as possible while maintaining claim validity.

The breadth of the present invention is not to be limited to the examples provided and/or the subject specification, but rather only by the scope of claim language associated with this disclosure.

The above description of illustrated embodiments is not intended to be exhaustive or to limit the embodiments to the precise forms disclosed. Although specific embodiments of and examples are described herein for illustrative purposes, various equivalent modifications can be made without departing from the spirit and scope of the disclosure, as will be recognized by those skilled in the relevant art. The teachings provided herein of the various embodiments can be applied to other devices that implement virtual or AR or hybrid systems and/or which employ user interfaces, not necessarily the example AR systems generally described above.

For instance, the foregoing detailed description has set forth various embodiments of the devices and/or processes via the use of block diagrams, schematics, and examples. As far as such block diagrams, schematics, and examples contain one or more functions and/or operations, it will be understood by those skilled in the art that each function and/or operation within such block diagrams, flowcharts, or examples can be implemented, individually and/or collectively, by a wide range of hardware, software, firmware, or virtually any combination thereof.

In one embodiment, the present subject matter may be implemented via Application Specific Integrated Circuits (ASICs). However, those skilled in the art will recognize that the embodiments disclosed herein, in whole or in part, can be equivalently implemented in standard integrated circuits, as one or more computer programs executed by one or more computers (e.g., as one or more programs running on one or more computer systems), as one or more programs executed by on one or more controllers (e.g., microcontrollers) as one or more programs executed by one or more processors (e.g., microprocessors), as firmware, or as virtually any combination thereof, and that designing the circuitry and/or writing the code for the software and or firmware would be well within the skill of one of ordinary skill in the art in light of the teachings of this disclosure.

When logic is implemented as software and stored in memory, logic or information can be stored on any computer-readable medium for use by or in connection with any processor-related system or method. In the context of this disclosure, a memory is a computer-readable medium that is an electronic, magnetic, optical, or other physical device or means that contains or stores a computer and/or processor program. Logic and/or the information can be embodied in any computer-readable medium for use by or in connection with an instruction execution system, apparatus, or device, such as a computer-based system, processor-containing system, or other system that can fetch the instructions from the instruction execution system, apparatus, or device and execute the instructions associated with logic and/or information.

In the context of this specification, a “computer-readable medium” can be any element that can store the program associated with logic and/or information for use by or in connection with the instruction execution system, apparatus, and/or device. The computer-readable medium can be, for example, but is not limited to, an electronic, magnetic, optical, electromagnetic, infrared, or semiconductor system, apparatus or device. More specific examples (a non-exhaustive list) of the computer readable medium would include the following: a portable computer diskette (magnetic, compact flash card, secure digital, or the like), a random access memory (RAM), a read-only memory (ROM), an erasable programmable read-only memory (EPROM, EEPROM, or Flash memory), a portable compact disc read-only memory (CDROM), digital tape, and other nontransitory media.

Any of the methods described herein can be performed with variations. For example, many of the methods may include additional acts, omit some acts, and/or perform acts in a different order than as illustrated or described.

The various embodiments described above can be combined to provide further embodiments. To the extent that they are not inconsistent with the specific teachings and definitions herein, all of the U.S. patents, U.S. patent application publications, U.S. patent applications, foreign patents, foreign patent applications and non-patent publications referred to in this specification and/or listed in the Application Data Sheet. Aspects of the embodiments can be modified, if necessary, to employ systems, circuits and concepts of the various patents, applications and publications to provide yet further embodiments.

These and other changes can be made to the embodiments in light of the above- detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

Moreover, the various embodiments described above can be combined to provide further embodiments. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. An eyepiece for an XR display system, comprising:
a diffractive optical element (DOE) to receive light associated with one or more frames of image data and direct the light to a user's eyes, the DOE comprising a diffraction structure having a waveguide substrate having a first side and a second side opposing the first side, a surface grating positioned on a first side of the waveguide substrate, and one or more optical layer pairs disposed between the waveguide substrate and the surface grating; and
each optical layer pair comprising a low index layer and a high index layer disposed directly on an exterior side of the low index layer, wherein the high index layer has a higher refractive index than the low index layer.

2. The eyepiece of claim 1, wherein the one or more optical layer pair(s) are disposed directly on first side of the waveguide substrate.

3. The eyepiece of claim 1, further comprising one or more intermediate layers disposed between the optical layer pair(s) and the waveguide substrate.

4. The eyepiece of claim 1, where the one or more optical layer pairs comprises:
a first optical layer pair on the first side of the waveguide substrate; and
a second optical layer pair on the second side of the waveguide substrate.

5. The eyepiece of claim 1, further comprising:
a second surface grating on the second side of the waveguide substrate, wherein the second optical layer pair is between the waveguide substrate and the second surface grating.

6. The eyepiece of claim 1, further comprising:
an input coupling grating disposed on the first side of the waveguide substrate; and
a first reflector disposed on the second side of the waveguide substrate.

7. The eyepiece of claim 1, wherein the waveguide substrate has a refractive index higher than the refractive index of the low index layer.

8. The eyepiece of claim 1, wherein:
the high index layer is comprised of a material selected from the group consisting of Si₃N₄, ZrO₂, TiO₂, SiC, ZnTe, GP, and BP, and the high index layer has a refractive index of greater than about 1.7; and
the low index layer is comprised of a material selected from the group consisting of MgF, SiO₂, a UV curable resin, and a thermal curable resins, and the low index layer has a refractive index of less than about 1.53.

9. The eyepiece of claim 1, wherein the grating surface(s) have a lower refractive index than the high index layer.

10. The eyepiece of claim 1, further comprising:
a top surface layer disposed on an exterior surface of the surface grating, the top surface layer having a refractive index higher than the refractive index of the low index layer.

11. An extended reality (XR) display system for delivering extended reality content to a user, comprising:
an image-generating source to provide one or more frames of image data;
a light modulator to transmit light associated with the one or more frames of image data; and
a diffractive optical element (DOE) to receive light associated with one or more frames of image data and direct the light to a user's eyes, the DOE comprising a diffraction structure having a waveguide substrate having a first side and a second side opposing the first side, a surface grating positioned on a first side of the waveguide substrate, and one or more optical layer pairs disposed between the waveguide substrate and the surface grating; and
each optical layer pair comprising a low index layer and a high index layer disposed directly on an exterior side of the low index layer, wherein the high index layer has a higher refractive index than the low index layer.

12. The system of claim 11, wherein the one or more optical layer pair(s) are disposed directly on first side of the waveguide substrate.

13. The system of claim 11, wherein the diffraction structure further comprises one or more intermediate layers disposed between the optical layer pair(s) and the waveguide substrate.

14. The system of claim 11, where the one or more optical layer pairs comprises:
a first optical layer pair on the first side of the waveguide substrate; and
a second optical layer pair on the second side of the waveguide substrate.

15. The system of claim 11, wherein the diffraction structure further comprises:
a second surface grating on the second side of the waveguide substrate, wherein the second optical layer pair is between the waveguide substrate and the second surface grating.

16. The system of claim 11, further comprising:
an input coupling grating disposed on the first side of the waveguide substrate; and
a first reflector disposed on the second side of the waveguide substrate.

17. The system of claim 11, wherein the waveguide substrate has a refractive index higher than the refractive index of the low index layer.

18. The system of claim 11, wherein:
the high index layer is comprised of a material selected from the group consisting of Si₃N₄, ZrO₂, TiO₂, SiC, ZnTe, GP, and BP, and the high index layer has a refractive index of greater than about 1.7; and
the low index layer is comprised of a material selected from the group consisting of MgF, SiO₂, a UV curable resin, and a thermal curable resins, and the low index layer has a refractive index of less than about 1.53.

19. The system of claim 11, wherein the grating surface(s) have a lower refractive index than the high index layer.

20. The system of claim 11, wherein the diffraction structure further comprises:
a top surface layer disposed on an exterior surface of the surface grating, the top surface layer having a refractive index higher than the refractive index of the low index layer.

21. (canceled)
